(19) United States
(12) Patent Application Publication
(10) Pub. No.: US 2024/0091855 A1
(43) Pub. Date: Mar. 21, 2024

(54) THREE DIMENSIONAL OBJECTS COMPRISING ROBUST ALLOYS

(71) Applicant: Velo3D, Inc., Campbell, CA (US)

(72) Inventors: Kimon Symeonidis, Easton, PA (US); Benyamin Buller, Cupertino, CA (US); Tasso Lappas, Pasadena, CA (US)

(21) Appl. No.: 18/212,796

(22) Filed: Jun. 22, 2023

Related U.S. Application Data
(63) Continuation of application No. 18/116,362, filed on Mar. 2, 2023, now abandoned.
Application No. 18/116,362 is a continuation of application No. 17/988,887, filed on Nov. 17, 2022, now abandoned.
Application No. 17/988,887 is a continuation of application No. 17/879,189, filed on Aug. 2, 2022, now abandoned.
Application No. 17/879,189 is a continuation of application No. 17/729,354, filed on Apr. 26, 2022, now abandoned.
Application No. 17/729,354 is a continuation of application No. 17/570,707, filed on Jan. 7, 2022, now abandoned.
Application No. 17/570,707 is a continuation of application No. 17/484,121, filed on Sep. 24, 2021, now abandoned.
Application No. 17/484,121 is a continuation of application No. 17/343,917, filed on Jun. 10, 2021, now abandoned.
Application No. 17/343,917 is a continuation of application No. 17/175,802, filed on Feb. 15, 2021, now abandoned.
Application No. 17/175,802 is a continuation of application No. 17/081,354, filed on Oct. 27, 2020, now abandoned.
Application No. 17/081,354 is a continuation of application No. 16/927,307, filed on Jul. 13, 2020, now abandoned.
Application No. 16/927,307 is a continuation of application No. 15/493,454, filed on Apr. 21, 2017, now abandoned.
(60) Provisional application No. 62/327,931, filed on Apr. 26, 2016.

(51) Int. Cl. B22F 7/06; B22F 10/28; B22F 10/368; B22F 12/90; B23K 15/00; B23K 15/02; B23K 26/03; B23K 26/342; B23K 26/70; B28B 1/00; B28B 17/00; B33Y 10/00; B33Y 30/00; B33Y 50/02

(52) U.S. Cl. CPC B22F 7/06; B22F 10/28; B22F 10/368; B22F 12/90; B23K 15/0086; B23K 15/02; B23K 26/034; B23K 26/342; B23K 26/702; B28B 1/001; B28B 17/0081; B33Y 10/00; B33Y 30/00; B33Y 50/02; B22F 10/32; B22F 2998/10

(57) ABSTRACT

The present disclosure provides three-dimensional (3D) printing methods, apparatuses, systems and software that effectuate formation of a robust 3D object comprising at least one metal alloy. The 3D object may be formed by 3D printing. The 3D object may comprise diminished defects (e.g., heat cracks). The alloy may be formed by diffusion. The diffusion may be a controlled diffusion. The control may comprise (e.g., real time) temperature control during the formation of the 3D object. The 3D object may comprise controlled crystal structure and/or metallurgical phases.

### CROSS-REFERENCE

This application is a continuation of U.S. patent application Ser. No. 18/116,362 filed Mar. 2, 2023; which is a continuation of U.S. patent application Ser. No. 17/988,887 filed Nov. 17, 2022; which is a continuation of U.S. patent application Ser. No. 17/879,189 filed Aug. 2, 2022; which is a continuation of U.S. patent application Ser. No. 17/727,354 filed Apr. 26, 2022; which is a continuation of U.S. patent application Ser. No. 17/570,707 filed Jan. 7, 2022; which is a continuation of U.S. patent application Ser. No. 17/484,121 filed Sep. 24, 2021; which is a continuation of U.S. patent application Ser. No. 17/343,917 filed Jun. 10, 2021; which is a continuation of U.S. patent application Ser. No. 17/175,802 filed Feb. 15, 2021; which is a continuation of U.S. patent application Ser. No. 17/081,354 filed Oct. 27, 2020; which is a continuation of U.S. patent application Ser. No. 16/927,307, filed Jul. 13, 2020; which is a continuation of U.S. patent application Ser. No. 15/493,454 filed Apr. 21, 2017; which claims priority to U.S. Provisional Application Ser. No. 62/327,931, filed on Apr. 26, 2016, titled “THREE DIMENSIONAL OBJECTS COMPRISING ROBUST ALLOYS”, which is entirely incorporated herein by reference.

### BACKGROUND

Three-dimensional (3D) objects may comprise desired (e.g., requested) alloys such as metal alloys. The desired alloys may be formed into 3D objects by heating (e.g., melting) the desired alloy or a mixture of its components, and subsequently cooling the desired alloy. Upon cooling, defects may be formed. The defects may lower the robustness of the alloy. The defects form a weak alloy. The defects may compromise the internal and/or external (e.g., surface) structure of the 3D object. For example, the defects may comprise fractures. The fractures may be formed upon cooling. The fractures may comprise hot tearing (e.g., hot cracking, or hot shortness). In some instances, it may be desired to control the crystal structure and/or metallurgical morphologies of the 3D object or portions thereof. The portions can be specific portions. For example, it may be desired to reduce the amount and/or size of dendrites in the alloy at certain portions of the 3D object (e.g., the entire 3D object). The crystal structure and/or metallurgic morphology may alter the physical property of the alloy (e.g., stress, or robustness). The present invention describes methods, systems, apparatuses, and/or software for generating the abovementioned desired (e.g., requested) 3D objects.

The 3D object may be formed by casting, or welding. The object may comprise a cast alloy or a wrought alloy. The 3D object may be formed in a mold. The 3D object may be formed by 3D printing. Three-dimensional (3D) printing (e.g., additive manufacturing) is a process for making a three-dimensional (3D) object of any shape from a design. The design may be in the form of a data source such as an electronic data source, or may be in the form of a hard copy. The hard copy may be a two-dimensional representation of a 3D object. The data source may be an electronic 3D model. 3D printing may be accomplished through an additive process in which successive layers of material are laid down one on top of each other. This process may be controlled (e.g., computer controlled, manually controlled, or both). A 3D printer can be an industrial robot.

3D printing can generate custom parts quickly and efficiently. A variety of materials can be used in a 3D printing process including elemental metal, metal alloy, ceramic, elemental carbon, or polymeric material. In a typical additive 3D printing process, a first material-layer is formed, and thereafter, successive material-layers (or parts thereof) are added one by one, wherein each new material-layer is added on a pre-formed material-layer, until the entire designed three-dimensional structure (3D object) is materialized.

3D models may be created utilizing a computer aided design package or via 3D scanner. The manual modeling process of preparing geometric data for 3D computer graphics may be similar to pinic arts, such as sculpting or animating. 3D scanning is a process of analyzing and collecting digital data on the shape and appearance of a real object. Based on this data, 3D models of the scanned object can be produced. The 3D models may include computer-aided design (CAD).

A large number of additive processes are currently available. They may differ in the manner layers are deposited to create the materialized structure. They may vary in the material or materials that are used to generate the designed structure. Some methods melt or soften material to produce the layers. Examples for 3D printing methods include selective laser melting (SLM), selective laser sintering (SLS), direct metal laser sintering (DMLS), shape deposition manufacturing (SDM) or fused deposition modeling (FDM). Other methods cure liquid materials using different technologies such as stereo lithography (SLA). In the method of laminated object manufacturing (LOM), thin layers (made inter alia of paper, polymer, metal) are cut to shape and joined together.

### SUMMARY

In an aspect described herein are methods, systems, apparatuses, and/or software for generating a 3D object comprising an alloy by diffusion. The alloy may comprise a metallic alloy or a ceramic alloy. For example, the alloy can be a metal alloy. For example, the alloy can be a ceramic alloy. In some embodiments, the disclosure related to a first metal and/or to a second metal, is respectively applicable to a first ceramic and/or a second ceramic. The diffusion may comprise diffusion of at least a first element into a material deficient in that first element. The diffusion may be controlled. The diffusion may result in a homogenous distribution of crystal phases and/or metallurgical morphologies. The diffusion may result in a three-dimensional (3D) object comprising diminished number of defects. The diffusion may result in a 3D object comprising diminished size of defects. The defects may comprise fractures. The fractures may comprise heat cracks.

In another aspect, a method of forming (e.g., printing) a 3D object comprises: (a) heating at least a portion of a powder bed by using an energy beam to form a first molten portion, wherein the powder bed comprises a mixture of at least a first powder and a second powder, wherein the first powder comprises a particulate material selected of the group consisting of elemental metal and metal alloy, wherein the second powder comprises a particulate material selected of the group consisting of elemental metal and metal alloy, wherein the first powder has a melting point that is higher than the melting point of the second powder, wherein the first powder is deficient in at least one component of the second powder, wherein heating is to a target temperature that is colder than a first temperature at which the first powder is completely liquid and hotter than or at a second temperature at which the second powder is completely liquid; and (b) translating the energy beam along to a path to form a second molten portion of the material bed, wherein the first molten portion and the second molten portion form at least a portion of the three-dimensional object that comprises a desired (e.g., requested) alloy, which desired alloy is formed from the components of the first powder and of the second powder.

At the target temperature, the first powder may be solid. At the target temperature, the first powder may be partially solid and partially liquid. The mixture may be a homogenous mixture. The mixture of the first powder and of the second powder can comprise a stoichiometric ratio of the desired alloy. As compared to conventional methodologies, the method can comprise a lesser degree of alloy segregation, reduced magnitude of stress and/or strain, smaller FLS of metallurgical morphologies, smaller percentage of dendrites as compared to cells, reduced shrinkage volume, or reduced number of deleterious phases. The conventional methodologies can comprise welding, or casting. The method may reduce the number of defects in the desired alloy as compared to conventional methodologies. The defect may comprise hot cracking. The method may further comprise controlling the formation of at least one metallurgical morphology in at least one fraction of the 3D object during formation of the 3D object. The method further comprises controlling the formation of at least one crystal structure in at least one fraction of the 3D object during formation of the 3D object. The first molten portion may comprise at least one melt pool, and further comprising controlling at least one characteristic of the melt pool during the heating. The method may further comprise controlling a diffusion rate of the at least one component into the first powder (e.g., by controlling the temperature of the position that is irradiated by the energy beam, and/or the close vicinity of that position). The close vicinity can be up to five diameters of a horizontal cross section of a melt pool formed by the irradiation. During the formation of the 3D object, the 3D object can be suspended anchorless in the powder bed. The desired alloy can be formed upon cooling. Cooling can comprise using a cooling member. Cooling may comprise naturally cooling. During the formation of the 3D object, the remainder of the powder bed (e.g., that is not transformed) is at an average ambient temperature. During the formation may comprise during the heating. During the formation may comprise during the translating. During the formation may comprise during both the heating and translating. During the formation of the 3D object, the pressure can be ambient pressure. During the formation may comprise during the heating. During the formation may comprise during the translating. During the formation may comprise during both the heating and translating. During the formation of the 3D object, the 3D object can be suspended anchorless in the powder bed. During the formation of the 3D object, the 3D object may float in the powder bed. The powder bed can be disposed adjacent to a platform. At times, during the formation of the 3D object, the 3D object may not be in contact with the platform. At times, during the formation of the 3D object, the 3D object can be devoid of auxiliary support. The method may further comprise controlling the temperature of the first molten portion to be below the melting point of the first powder, and at or above the melting point of the second powder. The method may further comprise controlling the temperature of the first molten portion to be substantially at the target temperature. The control may be in real time during the formation of the three-dimensional object. The control may be in real time the formation of the first and/or second molten portion. The first molten portion can comprise a first melt pool. The control may be in real time during the formation of the first melt pool. The second molten portion may comprise a second melt pool. The control may be in real time during the formation of the second melt pool.

In another aspect, a system for forming (e.g., printing) a 3D object comprises: an enclosure configured to accommodate a powder bed comprising a mixture of a first powder and a second powder, wherein the first powder comprises a particulate material selected of the group consisting of elemental metal and metal alloy, wherein the second powder comprises a particulate material selected of the group consisting of elemental metal and metal alloy, wherein the first powder has a melting point that is higher than the melting point of the second powder, wherein the first powder is deficient in at least one component of the second powder; an energy source configured to generate an energy beam that heats at least a portion of the powder bed to form a first molten portion, wherein heating is to a target temperature that is below a first temperature at which the first powder is completely liquid and at or above a second temperature at which the second powder is completely liquid, which energy source is disposed adjacent to the powder bed; and at least one controller operatively coupled to the powder bed and to the energy source, and is separately or collectively programmed to direct the energy beam to heat the at least the first portion of the powder bed to the target temperature to form the first molten portion as part of the 3D object.

The at least one controller can be further programed to direct the energy beam along a path to heat a second portion of the material bed to the target temperature and form a second molten portion as part of the 3D object. The at least one controller may control the energy beam to maintain a temperature below the melting point of the first powder, and at or above the melting point of the second powder. The control may be real-time control during the formation of the 3D object (e.g., during a layer of the 3D object). During the formation of the 3D object may comprise during the formation of the first molten portion.

In another aspect, an apparatus for forming (e.g., printing) a 3D object comprises at least one controller that is separately or collectively programmed to (a) direct an energy beam to heat at least a portion of a powder bed to form a first molten portion of the powder bed as part of the 3D object, wherein the powder bed comprises a mixture of a first powder and a second powder, wherein the first powder comprises a particulate material selected of the group consisting of elemental metal and metal alloy, wherein the second powder comprises a particulate material selected of the group consisting of elemental metal and metal alloy, wherein the first powder has a melting point that is higher than the melting point of the second powder, wherein the first powder is deficient in at least one component of the second powder, wherein heating is to a target temperature that is colder than a first temperature at which the first powder is completely liquid and hotter than or at a second temperature at which the second powder is completely liquid; and (b) direct an energy beam to translate along to a path to form a second molten portion of the material bed, wherein the first molten portion and the second molten portion form at least a portion of the three-dimensional object that comprises a desired alloy, which desired alloy is formed from the components of the first powder and of the second powder.

The at least one controller may comprise closed loop control. The at least one controller may comprise feed forward or feedback control. The at least one controller may comprise open loop control. The temperature set point of the closed loop control may be the target temperature. The first molten portion may comprise a melt pool, and wherein the controller is further programed to control at least one characteristic of the melt pool. The desired alloy may be formed upon cooling. The at least one controller can be further programmed to control the cooling. The at least one controller may be further programmed to control the heating. The control can comprise monitor, regulate, or alter.

In another aspect, a computer software product for forming (e.g., printing) a 3D object comprises a non-transitory computer-readable medium in which program instructions are stored, which instructions, when read by a computer, cause the computer to perform operations comprising: (a) receive an input signal from a sensor that measures a temperature of portion of a powder bed that is being heated, wherein the powder bed comprises a mixture of at least a first powder and a second powder, wherein the first powder comprises a particulate material selected of the group consisting of elemental metal and metal alloy, wherein the second powder comprises a particulate material selected of the group consisting of elemental metal and metal alloy, wherein the first powder has a melting point that is higher than the melting point of the second powder, wherein the first powder is deficient in at least one component of the second powder, wherein the powder bed is being heated to a target temperature that is colder than a first temperature at which the first powder is completely liquid and hotter than or at a second temperature at which the second powder is completely liquid; and (b) direct controlling the temperature of the heated portion to achieve or maintain the target temperature.

In another aspect, a 3D object comprising: successively solidified melt pools arranged in one or more sequential layers, which layers are formed of a metal alloy comprising at least a first elemental metal and a second elemental metal, which a melt pool within the solidified melt pools comprises at least one identifiable portion having a gradual diffusion pattern of the second elemental metal into the first elemental metal, which identifiable portion is shaped as a powder particle.

The portion object can comprise a planar diffusion front of the second elemental metal into the first elemental metal. The 3D can be substantially devoid of dendrites. The 3D can comprise at most about 1%, 2.5%, 5%, 7%, or 10% heat cracks relative to the volume of the 3D object (e.g., volume per volume). The 3D may be substantially devoid of heat cracks.

In one aspect, a method for printing a three-dimensional object comprises: (a) irradiating at a first position a first portion of a powder bed comprising a first powder and a second powder that is different from the first powder, which first powder comprises a first material, and wherein the second powder comprises a second material, which irradiating is to a temperature that is sufficient to melt the first powder of the first portion, and does not melt the second powder of the first portion, wherein the second powder comprises a particle that includes the second material; (b) facilitating diffusion of the first material to diffuse into the particle to form a requested alloy as at least a first segment of the three-dimensional object, which first material is of the first portion and which particle is of the first portion.

The requested alloy can be formed in situ during printing of the 3D object. The 3D printing method may facilitate diffusion of the first material (e.g., in a liquid phase) into one or more particles of the second material (e.g., in a solid phase) in situ during the 3D printing. The method may exclude co-melting of the first material and the second material to form the requested alloy. The method may exclude in situ co-melting of the first material with the second material during the 3D printing. The printing can be at ambient temperature and/or pressure. The remainder of the powder bed that does not transform (e.g., melt) to form the 3D object may be at ambient temperature during the 3D printing. The 3D printing can be in an atmosphere having a (e.g., substantially) constant pressure. The 3D printing can be at an atmosphere that is (e.g., substantially) devoid of a pressure gradient (e.g., across the powder bed). The powder bed can be at a (e.g., substantially) constant pressure during the 3D printing. Facilitating diffusion may comprise controlling the temperature of the powder bed to allow diffusion of the first material into at least one particle of the second material. Controlling the temperature may comprise cooling and/or heating the powder bed. Facilitating diffusion may comprise controlling the time between formation of two successive irradiations (e.g., between forming two successive melt pools). The first powder may have a melting temperature that is lower than that of the second powder. The first material may comprise an elemental metal or metal alloy. The second material may comprise an elemental metal or metal alloy. The first material may comprise a ceramic or a ceramic alloy. The second material may comprise a ceramic or a ceramic alloy. The requested alloy may comprise a diffusion pattern that may be formed from diffusion of the first material into the particle that includes the second material in operation (b). The requested alloy that may be formed by a method other than three-dimensional printing may be prone to cracking. The three-dimensional object may comprise comparatively a lesser amount of cracking. The method other than three-dimensional printing may comprise welding or casting. The requested alloy may comprise a metal alloy or a ceramic alloy. The requested alloy may comprise a wrought alloy or a cast alloy. The requested alloy may comprise a wrought alloy. The requested alloy may be prone to form cracks. The three-dimensional object may be devoid or substantially devoid of cracks. The cracks may be heat cracks. A second portion of the powder bed may be irradiated at a second position to a temperature that may be sufficient to melt the first powder in the second portion. The second powder in the second portion may not melt. The method may further comprise facilitating diffusion of the first material into the particle to form a requested alloy as at least a second segment of the three-dimensional object, which first material is of the second portion, and which particle is of the second portion. The first material may be allowed to diffuse into the particle (of the second material) to form a requested alloy as at least a second segment of the three-dimensional object. The first segment may be connected to the second segment as part of a layer of the three-dimensional object.

In another aspect, a system for printing a three-dimensional object comprises: an enclosure configured to accommodate a powder bed comprising a first powder and a second powder that is different from the first powder, which first powder comprises a first material, and which second powder comprises a second material, wherein the second powder comprises a particle that includes the second material; an energy source configured to generate an energy beam that melts a portion of the powder bed, wherein the energy source is operatively coupled to the enclosure; at least one controller that is operatively coupled to the powder bed and to the energy beam and is separately or collectively configured to perform: operation (i) direct the energy beam to irradiate at a first position a first portion of a powder bed to a temperature that is sufficient to melt the first powder of the first portion, and does not melt the second powder of the first portion, wherein the second powder comprises a particle that includes the second material; and operation (ii) facilitate diffusion of the first material into the particle to form a requested alloy as at least a first segment of the three-dimensional object, which first material is of the first portion, and wherein the particle is of the first portion.

The at least one controller may facilitate a real-time control of a temperature of the first portion and/or of an area adjacent to the first portion. The at least one controller may comprise controlling in real-time control of a temperature of the irradiated portion of the powder bed (e.g., the first portion) and/or of an area adjacent to the irradiated portion. Real-time can be during energy beam irradiation. The real-time control may comprise at least one feedback loop. The feedback loop may comprise sensing the temperature of the irradiated portion of the powder bed, and/or of an area adjacent to the irradiated portion. The sensing can be in real time during energy beam irradiation. Adjacent may be up to five diameters of a horizontal cross section of a melt pool. The melt pool may be formed by irradiation of the portion of the powder bed. The sensing may be in real time. Real time may be during formation of (I) a melt pool, (II) layer of the three-dimensional object, and/or (III) the three-dimensional object. A sensor may be operatively coupled to the enclosure. A sensor may be operatively coupled to the at least one controller. The at least one controller may be configured to control at least one characteristic of the energy beam based on a signal from the sensor. The sensor may be a temperature sensor. The at least one controller may further be configured to direct the energy beam to irradiate at a second position a second portion of the powder bed to a temperature that may be sufficient to melt the first powder in the second portion, and may not melt the second powder in the second portion. The at least one controller may be further configured to facilitate diffusion of the first material into the particle (of the second material) to form a requested alloy as at least a second segment of the three-dimensional object. The first segment may be connected to the second segment as part of a layer of the three-dimensional object. The second material may comprise an elemental metal or metal alloy. The first material may comprise a ceramic or a ceramic alloy. The second material may comprise a ceramic or a ceramic alloy. The requested alloy may comprise a diffusion pattern that may be formed from diffusion of the first material into the particle that may include the second material. The requested alloy may comprise a metal alloy or a ceramic alloy. The requested alloy may comprise a wrought alloy or a cast alloy. The requested alloy may comprise a wrought alloy. The requested alloy may be prone to form cracks. The three-dimensional object may be devoid or substantially devoid of cracks. The cracks may be heat cracks. The first powder may have a melting temperature that may be lower than that of the second powder.

In another aspect, an apparatus for printing a three-dimensional object comprises at least one controller that is operatively coupled to a powder bed and to an energy beam, wherein the powder bed comprises a first powder and a second powder that is different from the first powder, which first powder comprises a first material, and wherein the second powder comprises a second material, which at least one controller is separately or collectively configured to: (a) direct the energy beam to irradiate at a first position a first portion of the powder bed to a temperature that is sufficient to melt the first powder of the first portion, and does not melt the second powder of the first portion, wherein the second powder comprises a particle that includes the second material; and (b) facilitate diffusion of the first material into the particle to form a requested alloy as at least a first segment of the three-dimensional object, which first material is of the first portion, and wherein the particle is of the first portion.

The at least one controller may comprise a real-time control of a temperature of the irradiated portion of the powder bed and/or of an area adjacent to the irradiated portion. The real-time control may comprise at least one feedback loop. The feedback loop may comprise sensing the temperature of the irradiated portion of the powder bed, and/or of an area adjacent to the irradiated portion. Adjacent may be up to five diameters of a horizontal cross section of a melt pool. The melt pool may be formed by irradiation of the portion of the powder bed. The sensing may be in real time. Real time may be during formation of (i) a melt pool, (ii) layer of the three-dimensional object, or (iii) the three-dimensional object. A sensor may be operatively coupled to the enclosure. The sensor may be operatively coupled to the at least one controller. The at least one controller may be configured to control at least one characteristic of the energy beam based on a signal from the sensor. The sensor may be a temperature sensor. The at least one controller may be further configured to direct the energy beam to irradiate at a second position a second portion of the powder bed to a temperature that may be sufficient to melt the first powder in the second portion, and may not melt the second powder in the second portion. The at least one controller may be further configured to facilitate diffusion of the first material into the particle (of the second material) to form a requested alloy as at least a second segment of the three-dimensional object. The first segment may be connected to the second segment as part of a layer of the three-dimensional object. The second material may comprise an elemental metal or metal alloy. The first material may comprise a ceramic or a ceramic alloy. The second material may comprise a ceramic or a ceramic alloy. The requested alloy may comprise a diffusion pattern that may be formed from diffusion of the first material into the particle that may include the second material in operation (b). The requested alloy may comprise a metal alloy or a ceramic alloy. The requested alloy may comprise a wrought alloy or a cast alloy. The requested alloy may comprise a wrought alloy. The requested alloy may be prone to form cracks. The three-dimensional object may be devoid or substantially devoid of cracks. The cracks may be heat cracks. The first powder may have a melting temperature that may be lower than that of the second powder.

In another aspect, an apparatus for printing one or more 3D objects comprises an at least one controller that is programmed to direct a mechanism used in a three-dimensional printing methodology to implement (e.g., effectuate) the method disclosed herein, wherein the at least one controller is operatively coupled to the mechanism. The controller may implement any of the methods disclosed herein.

In another aspect, an apparatus for printing one or more 3D objects comprises at least one controller that is programmed to implement (e.g., effectuate) the method disclosed herein. The controller may implement any of the methods disclosed herein.

In another aspect, a system for printing one or more 3D objects comprises an apparatus (e.g., used in a 3D printing methodology) and at least one controller that is programmed to direct operation of the apparatus, wherein the at least one controller is operatively coupled to the apparatus. The apparatus may include any apparatus disclosed herein. The at least one controller may implement any of the methods disclosed herein. The controller may direct any system and/or apparatus (or component thereof) disclosed herein. The at least one controller may be operatively coupled to any system and/or apparatus (or component thereof) disclosed herein.

In another aspect, a computer software product, comprising a non-transitory computer-readable medium in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled to the mechanism. Wherein the mechanism comprises an apparatus or an apparatus component.

Another aspect of the present disclosure provides a non-transitory computer-readable medium comprising machine-executable code that, upon execution by one or more computer processors, implements any of the methods disclosed herein.

Another aspect of the present disclosure provides a non-transitory computer-readable medium comprising machine-executable code that, upon execution by one or more computer processors, effectuates directions of the controller(s) (e.g., as disclosed herein).

Another aspect of the present disclosure provides a computer system comprising one or more computer processors and a non-transitory computer-readable medium coupled thereto. The non-transitory computer-readable medium comprises machine-executable code that, upon execution by the one or more computer processors, can (i) implement any of the methods disclosed herein and/or (ii) effectuate directions of any of the controller(s) disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGS.” herein), of which:

FIG. 1 shows a schematic side view of a 3D printing system and apparatuses;

FIG. 2 schematically illustrates a phase diagram;

FIGS. 3A-3B show various schematic vertical cross sectional views of melt pools;

FIG. 4 shows a schematic side view planes;

FIG. 5 shows a top view of a 3D object;

FIG. 6 shows a coordinate system;

FIGS. 7A-7C show various 3D objects and schemes thereof;

FIG. 8 shows a schematic optical setup;

FIG. 9 shows a schematic computer system;

FIG. 10 shows a schematic path;

FIG. 11 shows schematic paths; and

FIGS. 12A-12C shows various schematic vertical cross sections of 3D objects.

The figures and components therein may not be drawn to scale. Various components of the figures described herein may not be drawn to scale.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an” and “the” are not intended to refer to only a singular entity, but include the general class of which a specific example may be used for illustration. The terminology herein is used to describe specific embodiments of the invention, but their usage does not delimit the invention. When ranges are mentioned, the ranges are meant to be inclusive, unless otherwise specified. For example, a range between value1 and value2 is meant to be inclusive and include value1 and value2. The inclusive range will span any value from about value1 to about value2. The term “between” as used herein is meant to be inclusive unless otherwise specified. For example, between X and Y is understood herein to mean from X to Y. The term “adjacent” or “adjacent to,” as used herein, includes ‘next to,’ ‘adjoining,’ ‘in contact with,’ and ‘in proximity to.’ In some instances, adjacent to may be ‘above’ or ‘below.’

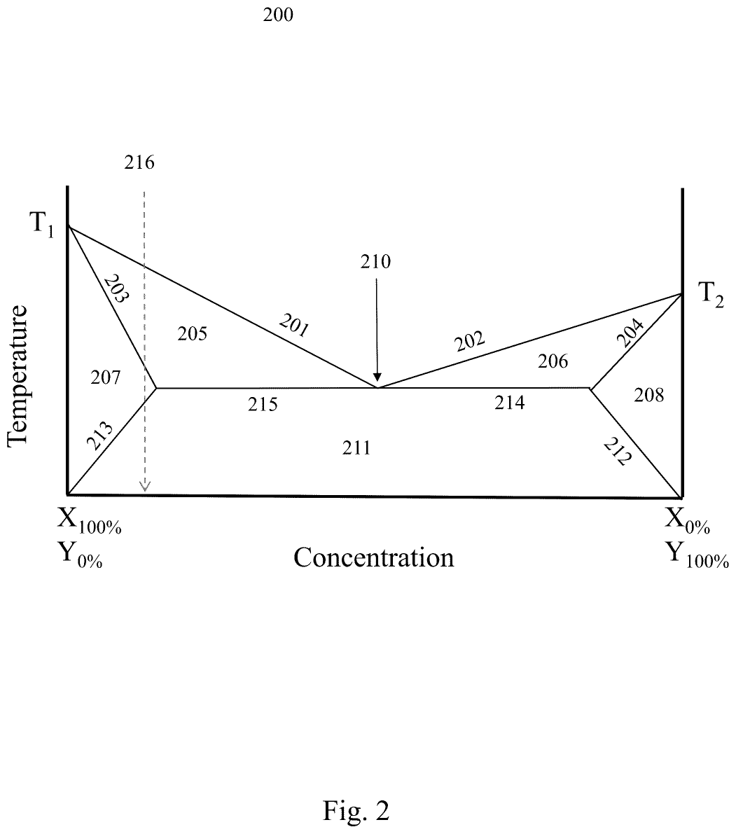

The methods, systems, apparatuses, and/or software may effectuate the formation of one or more objects (e.g., 3D objects) comprising alloys. For example, alloys having large temperature solidification ranges (e.g., a solidification temperature having a large temperature range) in which both solid and liquid (molten material) materials coexist. At least two metals in the resulting alloy may have a temperature difference between their respective liquidous temperature (e.g., melting point). The temperature difference may be sufficiently large to allow differentiation. Their melting temperature difference may be sufficiently large to allow controlling (e.g., maintaining) a target temperature that is between their respective melting points. FIG. 2 shows an example of a phase diagram of a binary alloy comprising component X and component Y. The melting point T1 of component X is higher than the melting point T2 of component Y. In the example shown in FIG. 2, the desired alloy can be of composition XₙYₘ, wherein n and m represent stoichiometric proportions. At least two components (e.g., elemental metals) in the resulting alloy may have a difference in their respective concentration of molten phase as compared to the solid phase. For example, one component may be substantially pure while the other may be a mixture (e.g., an alloy)). For example, both components may be (e.g., substantially) pure (e.g., elemental metals). The difference may be sufficient to allow a diffusion of one component (e.g., in the liquid phase) into another (e.g., in the solid phase). The difference may be sufficient to allow a diffusion of one component into the other in a workable time scale. The workable time scale may be at most about 1 day, 12 hours (h), 6 h, 5 h, 4 h, 3 h, 2 h, 1 h, 30 minutes, 15 minutes, 5 minutes, 240 s, 220 s, 200 s, 180 s, 160 s, 140 s, 120 s, 100 s, 80 s, 60 s, 40 s, 20 s, 10 s, 9 s, 8 s, 7 s, 6 s, 5 s, 4 s, 3 s, 2 s, or 1 s. The workable time scale be between any of the afore-mentioned time values (e.g., from about 1 s to about 1 day, from about 1 s to about 1 hour, from about 30 minutes to about 1 day, from about 20 s to about 240 s, from about 12 h to about 1 s, from about 12 h to about 30 min, from about 1 h to about 1 s, or from about 30 min to about 40 s). The diffusion gradient may be high. At least two components that make up the resulting alloy may have both a controllable melting temperature difference and a workable concentration gradient. The method may comprise diffusion of one component into another component to form the desired alloy. The diffusion may comprise a controlled diffusion solidification. The diffusion may take place while one component (e.g., metal type) that is included in the resulting alloy is solid, while another component that is included in the desired alloy is in a liquid (e.g., molten) state. The resulting desired alloy may comprise portions (e.g., areas, or locations) having a gradual diffusion pattern of one component (e.g., elemental metal) into another component. The gradual diffusion pattern may reflect the shape of the solid powder particles of the solid component.

In some embodiments, the 3D object is manufactured at a rate which includes the volumetric number of cubic millimeters of transformed material that is formed per second. For example, the rate of formation of a 3D object can be at least about 5 cubic millimeter (mm³)/second (sec), 10 mm³/sec, 15 mm³/sec, 20 mm³/sec, 25 mm³/sec, 30 mm³/sec, 32 mm³/sec, 35 mm³/sec, 40 mm³/sec, 45 mm³/sec, 50 mm³/sec, 55 mm³/sec, 60 mm³/sec, 64 mm³/sec, 65 mm³/sec, 70 mm³/sec, 75 mm³/sec, 80 mm³/sec, 85 mm³/sec, 90 mm³/sec, 95 mm³/sec, or 100 mm³/sec. The rate of formation of a 3D object can be between any of the afore-mentioned values, for example, from about 10 mm³/sec to about 100 mm³/sec, from about 10 mm³/sec to about 30 mm³/sec, from about 32 mm³/sec to about 64 mm³/sec, from about 30 mm³/sec to about 70 mm³/sec, or from about 70 mm³/sec to about 100 mm³/sec.

In some embodiments, the method excludes (e.g., be devoid of) deposition of a liquid material (e.g., onto the powder bed). In some embodiments, the system or apparatus excludes (e.g., is devoid of) a liquid dispenser, extruder (e.g., 3D printing extruder), and/or a liquid reservoir. In some embodiments, the method excludes using a polymer and/or resin. In some embodiments, the 3D object excludes a polymer and/or resin.

FIG. 2 represents schematically a phase diagram of component X and component Y. Line 201 represents the liquidous border line of material X, above which material X is in a liquid phase. Line 202 represents the liquidous border line of material Y, above which material Y is in a liquid phase. Line 203 represents the solidous border line of material X, below which material X is in a solid phase. Line 204 represents the solidous border line of material Y, below which material Y is in a solid phase. Lines 214 and 215 represents the solidous border line of material Y and X respectively, below which the desired alloy is in a solid phase. Area 207 represents a concentration of a X rich solid mixture. Area 208 represents a concentration of a Y rich solid mixture. Point 210 represents the eutectic point. Area 211 represents an area of a mixed solid phase having both X and Y (e.g., binary phase). Area 205 represents an area of mixed X rich solid and liquid. Area 206 represents an area of mixed Y rich solid and liquid. Line 212 represents the solvous boundary between a single-phase Y and a binary phase comprising X and Y. Line 213 represents the solvous boundary between a single phase X and a binary phase comprising X and Y. Line 216 represents a reduction in temperature of a mixture including X component and Y components, wherein the percentage of X and Y is smaller than 100% and larger than 0%. The percent can be weight percent, volume percent, or stoichiometric ratio represented as percentage.

The invention relates to alloys having a phase diagram with a temperature region in which the alloy is in a semi-solid phase. The temperature region can be extended. The temperature region can allow control of a target temperature, and workable concentration gradient. Workable, for example, can be different than an infinite time. Workable may refer to a workable time scale. In some instances, cooling within the extended temperature regime leads to at least one defect. The extended temperature regime may be at or above the solid alloy regime. The extended temperature regime may be at or above the solid alloy regime and the solidous border. An example of a solid alloy regime can be seen in FIG. 2, region 211. An example of solidous borders can be seen in FIG. 2, lines 214 and 215. The extended temperature regime can comprise a temperature difference (ΔT) of at least about 10° C., 20° C., 30° C., 40° C., 50° C., 60° C., 70° C., 80° C., 90° C., 100° C., 120° C., 150° C., 180° C., 200° C., 250° C., 500° C., or 700° C. between the first component (e.g., X) and the second component (e.g., Y). The extended temperature regime can comprise a temperature difference ΔT between any of the afore-mentioned temperature differences between the first component (e.g., X) and the second component (e.g., Y) (e.g., from about 10° C. to about 700° C., from about 10° C. to about 50° C., from about 50° C. to about 100° C., from about 50° C. to about 150° C., from about 100° C. to about 500° C., from about 20° C. to about 200° C., or from about 500° C. to about 700° C.). The defect may be a result of hot tearing (e.g., hot cracking, or hot shortness). In some instances, the extended temperature region (e.g., regime) may lead to at least one defect in the resulting alloy. The defect may comprise a structural defect (e.g., a fracture). The defect may comprise a metallurgical defect. The defect may comprise a crystallographic, or morphological defect. The defect may be a result of an irreversible failure (e.g., crack). The irreversible failure may be in the semisolid material (e.g., upon cooling). Without wishing to be bound to theory, the defect may result from inadequate compensation of solidification shrinkage by molten material flow in the presence of thermal stresses (e.g., upon cooling). For example, solid metallurgical morphologies (e.g., dendrites and/or cells, termed herein as “solidified structures”) may form (e.g., upon cooling) and coexist with an amount of molten material (e.g., liquid material). The amount of molten material may be small relative to the total amount of material. The solid metallurgical morphologies may connect to each other (e.g., interconnect). The connection may be a solid connection. The connection may be an irreversible connection. The connection may be reversible by heating (e.g., by melting). The connection may be irreversible upon cooling. As the overall volume of the solidifying molten material may shrink (e.g., upon cooling), the solidified structures (e.g., interconnected structures) may shrink at a different rate (e.g., slower rate) compared to the shrinkage of the cooling molten material. Shrink may comprise reduction in volume. The solidified structure may cause formation of defects in the (e.g., adjacent) solidifying molten material (e.g., as it cools). For example, the solidified structure may protrude out of a shrinking volume of the solidifying molten material. The solidified structures may be constrained (e.g., due to their interconnection). The solidified structures may crack the solidifying molten material (e.g., due to their interconnection and/or slower shrinking rate). In some instances, the molten material is trapped between solidified structures, which molten material has a first volume. The first volume may become excessive as the trapped molten material shrinks (e.g., upon cooling). As the trapped molten material shrinks, it may not occupy the entire first volume. The excessive volume may result in a formation of the defect.

The alloy may have a wide semi solid temperature range. The alloy may be prone to hot tearing. The alloy may be a binary alloy. The alloy may be other than a binary alloy. The alloy may be an Aluminum (Al) alloy comprising AlCu (e.g., 2XXX series such as, for example, 2024), AlSi, AlMg (e.g., 7XXX series), or AlLi. The alloy may be any alloy disclosed herein. The alloy may be a cast alloy. The alloy may be a wrought alloy.

The formation of the alloy may be generated from a mixture of substantially pure (e.g., completely pure or almost pure) elemental metals in the respective alloy ratio (e.g., stoichiometric ratio). The mixture may be a (e.g., substantially) homogenous mixture. The formation of the alloy may be formed from a mixture of at least one substantially pure (e.g., completely pure or almost pure) elemental metal and at least one alloy, which elemental metals in total are represented in the mixture in the stoichiometric ratio of the desired alloy. The formation of the alloy may result from mixing two or more alloys that in total (e.g., in the mixture) are represented in the stoichiometric ratio of the desired alloy. For example, an alloy comprising 4.5% of Copper (Cu) and 95.5% Aluminum may be formed by mixing a pure (e.g., substantially pure) Aluminum (Al) powder and an alloy comprising 67% Aluminum and 33% Copper in appropriate ratio to create the desired 4.5% of Cu and 95.5% Al ratio (e.g., 86 to 14 ratio of Aluminum to 67/33AlCu). The alloy may comprise a binary alloy comprising metal type X and metal type Y. Metal Y may comprise at least about 1%, 2%, 3%, 4%, 5%, 6%, 7%, 8%, 9%, 10%, 20%, 30%, 40%, or 50% of the total alloy. The Copper may comprise any percentage value with respect of the alloy between the afore-mentioned percentage values (e.g., from about 1% to about 50%, from about 1% to about 5%, from about 5% to about 30%, from about 30% to about 40%, or from about 3% to about 50%). The percentages may be weight-per-weight, volume-per-volume, or stoichiometric ratio of the elements in the alloy.

The method may comprise mixing at least a first powder and a second powder to form a powder mixture (e.g., homogenous). The powder mixture may be a (e.g., substantially) uniform mixture. The first powder may comprise an elemental metal or metal alloy. The second powder may comprise an elemental metal or metal alloy. The stoichiometric ratios of the elements in the combination of the first metal and the second metal may be the stoichiometric ratios of the desired alloy. The powder mixture may form a powder bed. At least a portion of the powder bed may be heated. Heating the powder bed may be using radiative heat. Heating the powder bed may be using directional heat or diffusive heat. Heating the powder bed may comprise using an energy beam. Heating the powder bed may be using a heater (e.g., radiative heater). The directional heat may comprise an electromagnetic, or charged particle beam. The directional heat may comprise a laser. The powder bed may be heated to a temperature in which at least one of the alloy constituents is in a solid state. The powder bed may be heated to a temperature in which at least one of the alloy constituents is in a liquid state. The powder bed may be heated to a temperature in which at least a first alloy constituent is in a solid state and at least a second alloy constituent is in a liquid state. In some instances, the second alloy constituent that is in a liquid state (e.g., molten) wets the first alloy constituent that is in a solid state. The melting point of the second alloy constituent may be lower than the melting point of the first alloy constituent. The constituent may be an elemental metal or a metal alloy. The second alloy constituent (e.g., liquid constituent) may diffuse into the first alloy constituent (e.g., solid constituent). The diffusion may continue until the desired alloy is formed. The rate of diffusion may relate to the temperature of the second alloy constituent. The rate of diffusion may relate to the temperature of the powder bed. The rate of diffusion may relate to the temperature of the first alloy constituent. The rate of diffusion may relate to the temperature at the surface of the first alloy constituent. The rate of diffusion may be altered. The alteration may be controlled by the heating. For example, the alteration may be controlled by at least one characteristic of the energy beam. The at least one characteristic of the energy beam may comprise dwell time, footprint, power per unit area, translation speed, fluence, flux, or intensity. The at least one characteristic of the heater may comprise dwell time, power per unit area, fluence, flux, or intensity.

The first powder and the second powder may have a melting point difference that allows for maintenance of the first powder in a solid state, and the second powder in a liquid state. The first powder and the second powder may have a concentration difference in at least one constituent of the second powder (that has a lower melting point). For example, the first powder may contain a lesser amount of element Y (e.g., a powder consisting of substantially pure elemental metal X), while the second powder may comprise a higher amount of element Y (e.g., a powder comprising a substantially pure elemental metal Y, or an alloy comprising elemental metals X and Y). Element Y may diffuse into the solid powder particles due to a diffusion gradient (e.g., since the solid powder particles comprise a lesser amount of element Y).

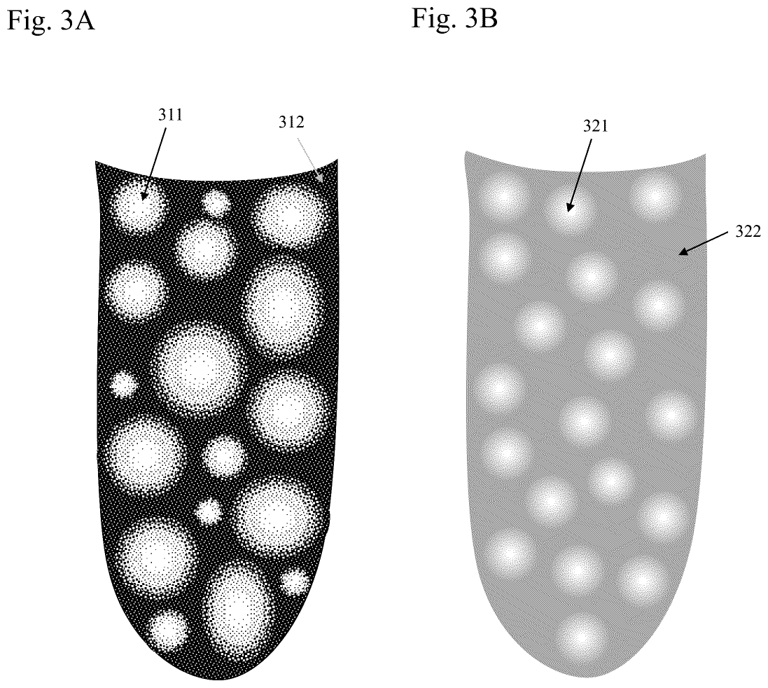

FIGS. 3A and 3B show schematic example of a vertical cross section in a melt pool. FIG. 3A shows a melt pool that includes a desired alloy 312 and portions comprising gradient diffusion of the second material into the first material 311, which first material remained solid while the second material was liquid (e.g., molten). The portions illustrate various shapes that represent the various powder particle shapes of the first material that remained solid, which various particle have a distribution of shapes and sizes. FIG. 3B shows a melt pool that includes a desired alloy 322 and portions comprising gradient diffusion of the second material into the first material 321, which first material remained solid while the second material was liquid (e.g., molten). The portions illustrate various sizes that represent the various powder particle sizes of the first material that remained solid, which powder comprises spherical particles. FIGS. 3A and 3B represent different diffusion gradients of the second material into the first material, which FIG. 3B showing a smoother diffusion profile.

The method can be utilized in forming (e.g., printing) a 3D object from a mold. The method can be utilized in a powder based 3D printing system. The method can be utilized in granular 3D printing. The method can be utilized in an additive manufacturing 3D printing system. For example, using methods such as SLS, SLM, DMLS, EBM, or SHS. The method can be utilized using any of the methods describe in Patent Application serial number PCT/US15/36802, titled “APPARATUSES, SYSTEMS AND METHODS FOR THREE-DIMENSIONAL PRINTING” that was filed on Jun. 19, 2015; in Provisional Patent Application Ser. No. 62/307,254 that was filed on Mar. 11, 2016, titled “SYSTEMS, APPARATUS AND METHODS FORMING A SUSPENDED OBJECT;” in Patent Application serial number PCT/US16/034454, titled “THREE-DIMENSIONAL OBJECTS FORMED BY THREE-DIMENSIONAL PRINTING” that was filed on May 26, 2016; in Provisional Patent application Ser. No. 62/265,817, filed on Dec. 10, 2015, titled “APPARATUSES, SYSTEMS AND METHODS FOR EFFICIENT THREE DIMENSIONAL PRINTING;” in Provisional Patent Application Ser. No. 62/317,070 that was filed on Apr. 1, 2016, titled “APPARATUSES, SYSTEMS AND METHODS FOR EFFICIENT THREE-DIMENSIONAL PRINTING;” in patent application Ser. No. 15/374,535, titled “SKILLFUL THREE-DIMENSIONAL PRINTING” that was filed on Dec. 9, 2016; in Patent Application serial number PCT/US16/66000, titled “SKILLFUL THREE-DIMENSIONAL PRINTING,” that was filed on Dec. 9, 2016; or in Provisional Patent Application Ser. No. 62/320,334 that was filed on Apr. 8, 2016, titled “METHODS, SYSTEMS, APPARATUSES, AND SOFTWARE FOR ACCURATE THREE-DIMENSIONAL PRINTING;” in Patent Application serial number PCT/US17/18191, that was filed on Feb. 16, 2017, titled “ACCURATE THREE-DIMENSIONAL PRINTING”; in patent application Ser. No. 15/435,078, that was filed on Feb. 16, 2017, titled “ACCURATE THREE-DIMENSIONAL PRINTING”; or in Patent Application serial number EP17156707.6, that was filed on Feb. 17, 2017, titled “ACCURATE THREE-DIMENSIONAL PRINTING;” all of which are incorporated herein by reference in their entirety. During the 3D printing process, the powder bed may be heated (e.g., preheated) or non-heated. The powder bed may be at an average or mean ambient temperature while the energy beam transforms a portion of the powder bed into a transformed (e.g., molten) material comprising the second powder having the lower melting point, while keeping the first powder at a solid state below its melting point.

The liquefying temperature of the powder material can be the temperature at or above which at least part of the powder material transitions from a solid to a liquid phase at a given pressure. The liquefying temperature can be equal to a liquidus temperature where the entire material is at a liquid state at a given pressure. In some embodiments, the powder bed temperature is below the liquefying temperature of the first powder. At times, as the powder bed temperature is below the liquefying temperature of the first powder, and at least a portion of the powder bed is heated to a temperature in which the second powder is at a liquidous state (e.g., completely molten state). In some embodiments, at least a portion of the powder bed reaches the liquefying temperature of the first powder, but not the liquidous temperature of the first powder. At times, as at least a portion of the powder bed reaches the liquefying temperature of the first powder, the second powder is at a liquidous state (e.g., completely molten state).

In some embodiments, the powder bed temperature is below the melting temperature of the first powder. At times, as the powder bed temperature is below the melting temperature of the first powder, and at least a portion of the powder bed is heated to a temperature in which the second powder is at a completely molten state. In some embodiments, at least a portion of the powder bed reaches a temperature in which the first powder is partially molten and partially solid (e.g., incompletely molten). At times, as at least a portion of the powder bed reaches a temperature in which the first powder is partially molten and partially solid (e.g., incompletely molten), the second powder is at completely molten.

The target temperature may be controlled. The temperature (e.g., maximum temperature, or peak temperature) of the molten portion may be controlled. The temperature (e.g., maximum temperature, or peak temperature) of the melt pool (e.g., within the portion) may be controlled. The temperature control may comprise controlling the heating or cooling (e.g., of the powder bed, molten portion, and/or melt pool). Controlling the heating may comprise controlling the energy source and/or energy beam. For example, controlling the heating may comprise controlling at least one characteristic of the energy source and/or energy beam. Controlling the cooling may comprise controlling the cooling member (e.g., heat sink). Controlling the temperature may comprise controlling the temperature alteration rate. Temperature alteration may comprise cooling and/or heating. The control may be a real-time control during the formation of the 3D object. The control may be a real-time control during the formation of the molten portion in the powder bed. The control may be a real-time control during the formation of the melt pool. For example, the control may be any one mentioned in provisional patent application Ser. No. 62/325,402, in Patent Application serial number PCT/US17/18191, in patent application Ser. No. 15/435,078, or in Patent Application serial number EP17156707.6, all of which are incorporated herein by reference in their entirety. Control may comprise monitor, adjust, regulate, modulate, alter, vary, or maintain.

In some embodiments, formation of a particular metallurgical morphology and/or crystal structure (e.g., crystallographic phase) may be controlled. For example, at least a portion of the 3D object may comprise a controlled metallurgic morphology and/or crystal structure. The control may comprise one or more portions of the 3D object. The control may comprise one or more portions within a layer of hardened material as part of the 3D object. For example, the core of the 3D object may comprise a first crystal structure and/or metallurgic morphology, while the exterior of the 3D object may comprise a second crystal structure and/or metallurgic morphology. For example, a ledge (e.g., blade) of the 3D object may comprise a first crystal structure and/or metallurgic morphology, while a second portion (e.g., the axis to which the blade is attached) of the 3D object may comprise a second crystal structure and/or metallurgic morphology.

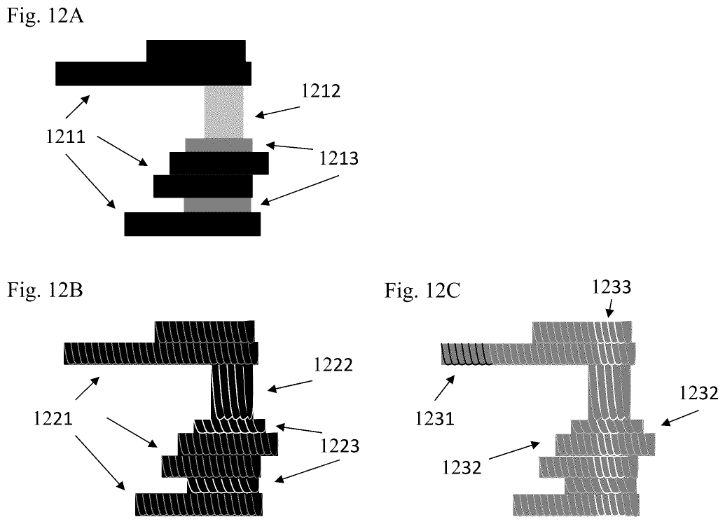

FIGS. 12A-12C show examples of a vertical cross section in various 3D objects. FIG. 12A shows an example wherein various layers are composed of a different material than other layers. For example, layers 1211 are formed of a first material, layer 1212 is formed of a second material, and layers 1213 are formed of a third material. FIG. 12B shows an example wherein various layers are generated from melt pools having various FLSs. For example, layer 1222 is formed from high melt pools, layers 1223 is formed of short melt pools, and layers 1221 are formed from short melt pools. FIG. 12C shows an example wherein various portions within the 3D object are generated from melt pools having different material characteristics. For example, melt pools of the group 1231 (e.g., colored black) have a first material characteristics, melt pools of the group 1232 (e.g., colored gray) have a second material characteristics, and melt pools of the group 1233 (e.g., colored white) have a third material characteristics. The material characteristics may comprise grain orientation, material density, degree of compound segregation to grain boundaries, degree of element segregation to grain boundaries, material phase, metallurgical phase, material porosity, crystal phase, crystal structure, material type, strength, strain, elasticity, or defect percentage.

As compared to an alloy having the same stoichiometry that is formed in conventional methods, the resulting desired alloy may comprise a lesser degree of alloy segregation, reduced magnitude of stress and/or strain, smaller FLS of metallurgical morphologies (e.g., smaller dendrites and/or cells), smaller percentage of dendrites (e.g., no dendrites) as compared to cells, reduced shrinkage volume, or reduced amount of deleterious phases (e.g., lack thereof). In some embodiments, the diffusion front of the second alloy component (e.g., elemental metal type) into the first alloy component is a planar diffusion front (e.g., substantially planar diffusion front).

Three-dimensional printing (also “3D printing”) generally refers to a process for generating a 3D object. For example, 3D printing may refer to sequential addition of material layer or joining of material layers (or parts of material layers) to form a 3D structure, in a controlled manner. The controlled manner may include automated control. In the 3D printing process, the deposited material can be transformed (e.g., fused, sintered, melted, bound or otherwise connected) to subsequently hardened and form at least a part of the 3D object. Fusing (e.g., sintering or melting) binding, or otherwise connecting the material is collectively referred to herein as transforming the material (e.g., powder material). Fusing the material may include melting or sintering the material. Binding can comprise chemical bonding. Chemical bonding can comprise covalent bonding. Examples of 3D printing include additive printing (e.g., layer by layer printing, or additive manufacturing). 3D printing may include layered manufacturing. 3D printing may include rapid prototyping. 3D printing may include solid freeform fabrication. 3D printing may include direct material deposition. The 3D printing may further comprise subtractive printing.

3D printing methodologies can comprise extrusion, wire, granular, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP).

3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

The methods, apparatuses, systems, and/or software of the present disclosure can be used to form 3D objects for various uses and applications. Such uses and applications include, without limitation, electronics, components of electronics (e.g., casings), machines, parts of machines, tools, implants, prosthetics, fashion items, clothing, shoes, or jewelry. The implants may be directed (e.g., integrated) to a hard, a soft tissue, or to a combination of hard and soft tissues. The implants may form adhesion with hard and/or soft tissue. The machines may include a motor or motor part. The machines may include a vehicle. The machines may comprise aerospace related machines. The machines may comprise airborne machines. The vehicle may include an airplane, drone, car, train, bicycle, boat, or shuttle (e.g., space shuttle). The machine may include a satellite or a missile. The uses and applications may include 3D objects relating to the industries and/or products listed herein.

The present disclosure provides systems, apparatuses, software, and/or methods for 3D printing of a desired 3D object from a powder material. The object can be pre-ordered, pre-designed, pre-modeled, or designed in real time (i.e., during the process of 3D printing). The 3D printing method can be an additive method in which a first layer is printed, and thereafter a volume of a material is added to the first layer as separate sequential layer (or parts thereof). Each additional sequential layer (or part thereof) can be added to the previous layer by transforming (e.g., fusing (e.g., melting)) a fraction of the powder material. The transformed (e.g., molten) material may harden to form at least a portion of the (hard) 3D object. The hardening can be actively induced (e.g., by cooling) or can occur without intervention (e.g., naturally).

The 3D printing may be performed in an enclosure. During the 3D printing (e.g., during the transformation stage) the pressure of the enclosure atmosphere (e.g., comprising at least one gas) may be an ambient pressure. During the formation of the 3D object (e.g., during the formation of the layer of hardened material or a portion thereof), a remainder of the powder bed that did not transform, may be at an ambient temperature. The ambient temperature may be an average or mean temperature of the remainder. During the formation of the 3D object (e.g., during the formation of the layer of hardened material or a portion thereof), a remainder of the powder bed that did not transform, may not be heated (e.g., actively heated). For example, the remainder may not be heated beyond an (e.g., average or mean) ambient temperature. During the formation of the 3D object (e.g., during the formation of the layer of hardened material or a portion thereof), a remainder of the powder bed that did not transform, may be at a temperature of at most about 10 degrees Celsius (° C.), 20° C., 25° C., 30° C., 40° C., 50° C., 60° C., 70° C., 80° C., 90° C., 100° C., 150° C., 200° C., 250° C., 300° C., 350° C., 400° C., 450° C., 500° C., 550° C., 600° C., 650° C., 700° C., 750° C., 800° C., 850° C., 900° C., or 1000° C. During the formation of the 3D object (e.g., during the formation of the layer of hardened material or a portion thereof), a remainder of the powder bed that did not transform, may be at a temperature between any of the above-mentioned temperature values (e.g., from about 10° C. to about 1000° C., from about 100° C. to about 600° C., from about 200° C. to about 500° C., or from about 300° C. to about 450° C.). During the formation of the 3D object (e.g., during the formation of the layer of hardened material or a portion thereof), a remainder of the powder bed that did not transform, may be at an ambient temperature. For example, the average or mean temperature of the remainder may be an ambient temperature.

The 3D object may be generated by providing a first layer of powder material (e.g., powder) in an enclosure; transforming at least a portion of the powder material in the first layer to form a transformed material. The transforming may be effectuated (e.g., conducted) with the aid of an energy beam. The energy beam may travel along a path. The path may comprise hatching. The path may comprise a vector or a raster path. The method may further comprise hardening the transformed material to form a hardened material as part of the 3D object. In some embodiments, the transformed material may be the hardened material as part of the 3D object. The method may further comprise providing a second layer of pre-transformed material adjacent to (e.g., above) the first layer and repeating the transformation process delineated above.

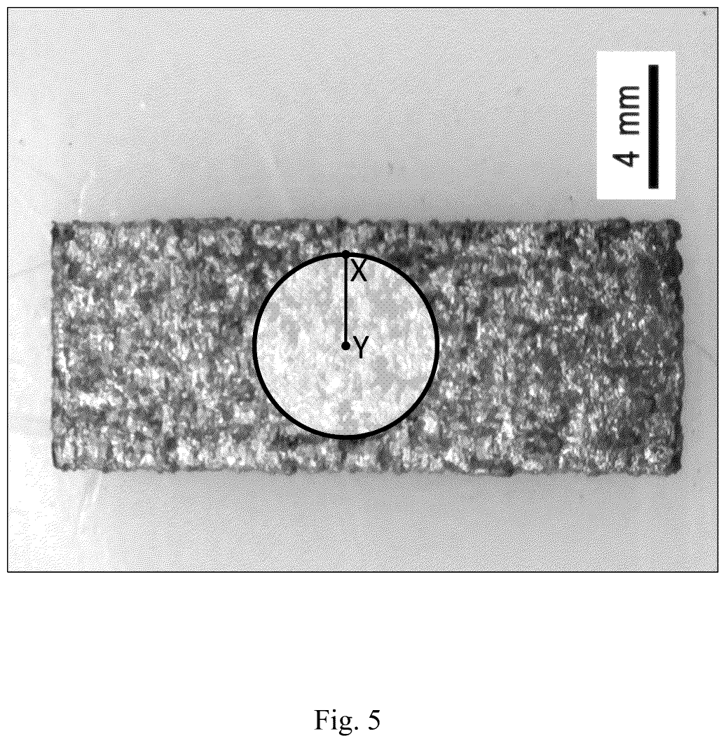

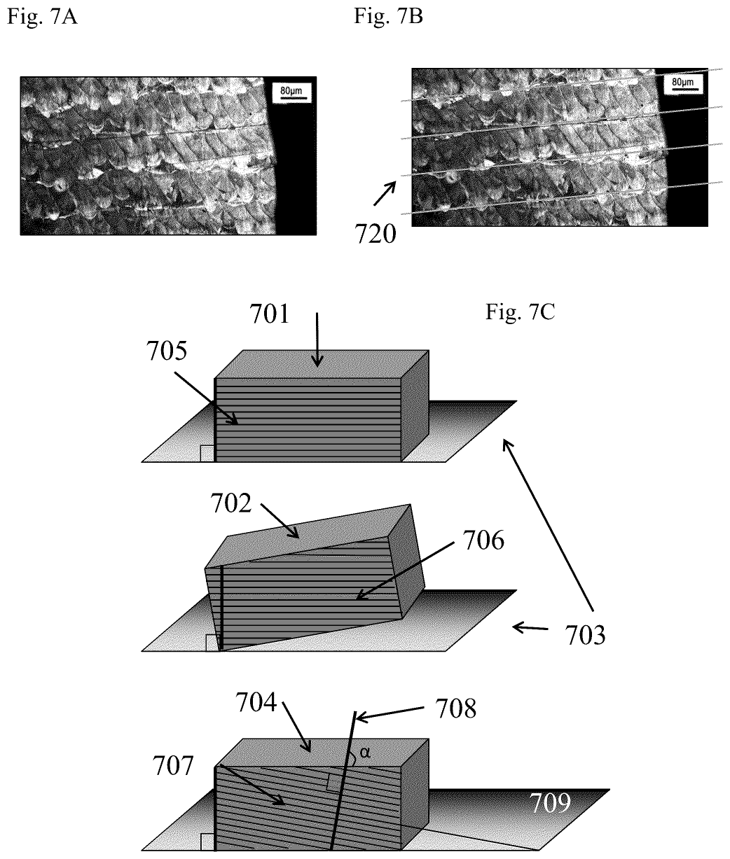

The 3D object can be an extensive 3D object. The 3D object can be a large 3D object. The 3D object may comprise a large hanging structure (e.g., wire, ledge, shelf, or 3D plane). Large may be a 3D object having a fundamental length scale of at least about 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. In some instances, The fundamental length scale (e.g., the diameter, spherical equivalent diameter, diameter of a bounding circle, or largest of height, width and length; abbreviated herein as “FLS”) of the printed 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object can be at most about 1000 m, 500 m, 100 m, 80 m, 50 m, 10 m, 5 m, 4 m, 3 m, 2 m, 1 m, 90 cm, 80 cm, 60 cm, 50 cm, 40 cm, 30 cm, 20 cm, 10 cm, or 5 cm. In some cases, the FLS of the printed 3D object may be in between any of the afore-mentioned FLSs (e.g., from about 50 μm to about 1000 m, from about 120 μm to about 1000 m, from about 120 μm to about 10 m, from about 200 μm to about 1 m, from about 1 cm to about 100 m, from about 1 cm to about 1 m, from about 1 m to about 100 m, or from about 150 μm to about 10 m). The FLS (e.g., horizontal FLS) of the layer of hardened material may have any value listed herein for the FLS of the 3D object. The example in FIG. 5 shows a top view of the layer of hardened material, which is a lateral (e.g., horizontal) portion of the layer of hardened material. The example in FIG. 7C shows a lateral portion 701 of the layer of hardened material (e.g., the top layer in the 7C scheme).

The material (e.g., powder material, transformed material, or solid material) may comprise elemental metal, or metal alloy. In some embodiments, the material may be devoid of an organic material, for example, a polymer or a resin. In some embodiments, the material may exclude an organic material (e.g., polymer).

The material may comprise a powder material. The material may comprise a solid material. The material may comprise one or more particles or clusters. The term “powder,” as used herein, generally refers to a solid having fine particles. The powder may also be referred to as “particulate material.” Powders may be granular materials. The powder particles may comprise micro particles. The powder particles may comprise nanoparticles or microparticles. In some examples, a powder comprising particles having an average fundamental length scale (e.g., the diameter, spherical equivalent diameter, diameter of a bounding circle, or the largest of height, width and length; herein designated as “FLS”) of at least about 5 nanometers (nm), 10 nm, 20 nm, 30 nm, 40 nm, 50 nm, 100 nm, 200 nm, 300 nm, 400 nm, 500 nm, 1 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, or 100 μm. The particles comprising the powder may have an average fundamental length scale of at most about 100 μm, 80 μm, 75 μm, 70 μm, 65 μm, 60 μm, 55 μm, 50 μm, 45 μm, 40 μm, 35 μm, 30 μm, 25 μm, 20 μm, 15 μm, 10 μm, 5 μm, 1 μm, 500 nm, 400 nm, 300 nm, 200 nm, 100 nm, 50 nm, 40 nm, 30 nm, 20 nm, 10 nm, or 5 nm. In some cases, the powder may have an average fundamental length scale between any of the values of the average particle fundamental length scale listed above (e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm).

The powder can be composed of individual particles. The individual particles can be spherical, oval, prismatic, cubic, wires, or irregularly shaped. The particles can have a FLS. The powder can be composed of a homogenously shaped particle mixture such that all of the particles have substantially the same shape and FLS magnitude within at most 1%, 5%, 8%, 10%, 15%, 20%, 25%, 30%, 35%, 40%, 50%, 60%, or 70%, distribution of FLS. In some cases, the powder can be a heterogeneous mixture such that the particles have variable shape and/or FLS magnitude.

At least parts of the layer of powder material can be transformed to a transformed material (e.g., using an energy beam) that may subsequently form at least a fraction (also used herein “a portion,” or “a part”) of a hardened (e.g., solidified) 3D object. At times a layer of transformed or hardened material may comprise a cross section of a 3D object (e.g., a horizontal cross section). The layer may correspond to a cross section of a desired 3D object (e.g., a model). At times a layer of transformed or hardened material may comprise a deviation from a cross section of a model of a 3D object. The deviation may include vertical or horizontal deviation. A powder material layer (or a portion thereof) can have a thickness (e.g., layer height) of at least about 0.1 micrometer (μm), 0.5 μm, 1.0 μm, 10 μm, 50 μm, 100 μm, 150 μm, 200 μm, 300 μm, 400 μm, 500 μm, 600 μm, 700 μm, 800 μm, 900 μm, or 1000 μm. A powder material layer (or a portion thereof) can have a thickness of at most about 1000 μm, 900 μm, 800 μm, 700 μm, 60 μm, 500 μm, 450 μm, 400 μm, 350 μm, 300 μm, 250 μm, 200 μm, 150 μm, 100 μm, 75 μm, 50 μm, 40 μm, 30 μm, 20 μm, 10 μm, 5 μm, 1 μm, or 0.5 μm. A powder material layer (or a portion thereof) may have any value in between the afore-mentioned layer thickness values (e.g., from about 1000 μm to about 0.1 μm, 800 μm to about 1 μm, from about 600 μm to about 20 μm, from about 300 μm to about 30 μm, or from about 1000 μm to about 10 μm). The material composition of at least one layer within the powder bed may differ from the material composition within at least one other layer in the powder bed. The material composition of at least one layer within the 3D object may differ from the material composition within at least one other layer in the 3D object. The difference (e.g., variation) may comprise difference in crystal or grain structure. The variation may comprise variation in grain orientation, material density, degree of compound segregation to grain boundaries, degree of element segregation to grain boundaries, material phase, metallurgical phase, material porosity, crystal phase, crystal structure, or material type. The microstructure of the printed object may comprise planar structure, cellular structure, columnar dendritic structure, or equiaxed dendritic structure.

The powder material of at least one layer in the powder bed may differ in the FLS of its particles (e.g., powder particles) from the FLS of the powder material within at least one other layer in the powder bed. A layer may comprise two or more material types at any combination. For example, two or more elemental metals, at least one elemental metal and at least one alloy; two or more metal alloys. All the layers of powder material deposited during the 3D printing process may be of the same (e.g., substantially the same) material composition. In some instances, a metal alloy is formed in situ during the process of transforming at least a portion of the powder bed. In some instances, a metal alloy is not formed in situ during the process of transforming at least a portion of the powder bed. In some instances, a metal alloy is formed prior to the process of transforming at least a portion of the powder bed. In some instances, a first metal alloy is formed prior to the process of transforming at least a portion of the powder bed and a second (e.g., desired) metal alloy is formed during the transforming of at least a portion of the powder bed. In the case of a multiplicity (e.g., mixture) of powder materials, one powder material may be used as support (i.e., supportive powder), as an insulator, as a cooling member (e.g., heat sink), as a precurson in the desired alloy formation, or as any combination thereof.

In some instances, adjacent components in the powder bed are separated from one another by one or more intervening layers. In an example, a first layer is adjacent to a second layer when the first layer is in direct contact with the second layer. In another example, a first layer is adjacent to a second layer when the first layer is separated from the second layer by at least one layer (e.g., a third layer). The intervening layer may be of any layer size.

The powder material can be chosen such that the material is the desired and/or otherwise predetermined material for the 3D object. A layer of the 3D object may comprise a single type of material. For example, a layer of the 3D object may comprise a single metal alloy type. In some examples, a layer within the 3D object may comprise several types of material (e.g., an elemental metal and an alloy, several ally types, several alloy phases, or any combination thereof). In certain embodiments each type of material comprises only a single member of that type. For example: a single member of metal alloy (e.g., Aluminum Copper alloy). In some cases, a layer of the 3D object comprises more than one type of material. In some cases, a layer of the 3D object comprises more than one member of a material type.

The elemental metal can be an alkali metal, an alkaline earth metal, a transition metal, a rare earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare earth metal can be a lanthanide, or an actinide. The lanthanide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

The metal alloy can be an iron based alloy, nickel based alloy, cobalt based allow, chrome based alloy, cobalt chrome based alloy, titanium based alloy, magnesium based alloy, copper based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising a device, medical device (human & veterinary), machinery, cell phone, semiconductor equipment, generators, turbine, stator, motor, rotor, impeller, engine, piston, electronics (e.g., circuits), electronic equipment, agriculture equipment, gear, transmission, communication equipment, computing equipment (e.g., laptop, cell phone, i-pad), air conditioning, generators, furniture, musical equipment, art, jewelry, cooking equipment, or sport gear. The impeller may be a shrouded (e.g., covered) impeller that is produced as one piece (e.g., comprising blades and cover) during one 3D printing process. The 3D object may comprise a blade. The impeller may be used for pumps (e.g., turbo pumps). The impeller and/or blade may be any of the ones described in provisional patent application Ser. No. 62/325,402, in Patent Application serial number PCT/US17/18191, in patent application Ser. No. 15/435,078, or in Patent Application serial number EP17156707.6, all of which are incorporated herein by reference in their entirety. The metal (e.g., alloy or elemental) may comprise an alloy used for products for human and/or veterinary applications comprising implants, or prosthetics. The metal alloy may comprise an alloy used for applications in the fields comprising human and/or veterinary surgery, implants (e.g., dental), or prosthetics.

The alloy may include a superalloy. The alloy may include a high-performance alloy. The alloy may include an alloy exhibiting at least one of: excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron alloy comprises Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may comprise cast iron, or pig iron. The steel may comprise Bulat steel, Chromoly, Crucible steel, Damascus steel, Hadfield steel, High speed steel, HSLA steel, Maraging steel, Reynolds 531, Silicon steel, Spring steel, Stainless steel, Tool steel, Weathering steel, or Wootz steel. The high-speed steel may comprise Mushet steel. The stainless steel may comprise AL-6XN, Alloy 20, celestrium, marine grade stainless, Martensitic stainless steel, surgical stainless steel, or Zeron 100. The tool steel may comprise Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade steel such as 440F, 410, 312, 430, 440A, 440B, 440C, 304, 305, 304L, 304L, 301, 304LN, 301LN, 2304, 316, 316L, 316LN, 316, 316LN, 316L, 316L, 316, 317L, 2205, 409, 904L, 321, 254SMO, 316Ti, 321H, or 304H. The steel may comprise stainless steel of at least one crystalline structure selected from the group consisting of austenitic, superaustenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may comprise 316L, or 316LVM. The steel may comprise 17-4 Precipitation Hardening steel (e.g., type 630, a chromium-copper precipitation hardening stainless steel, 17-4PH steel).

The titanium-based alloy may comprise alpha alloy, near alpha alloy, alpha and beta alloy, or beta alloy. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances, the titanium base alloy comprises Ti-6Al-4V or Ti-6Al-7Nb.

The Nickel alloy may comprise Alnico, Alumel, Chromel, Cupronickel, Ferronickel, German silver, Hastelloy, Inconel, Monel metal, Nichrome, Nickel-carbon, Nicrosil, Nisil, Nitinol, or Magnetically “soft” alloys. The magnetically “soft” alloys may comprise Mu-metal, Permalloy, Supermalloy, or Brass. The brass may comprise Nickel hydride, Stainless or Coin silver. The cobalt alloy may comprise Megallium, Stellite (e. g. Talonite), Ultimet, or Vitallium. The chromium alloy may comprise chromium hydroxide, or Nichrome.

The aluminum alloy may comprise AA-8000, Al—Li (aluminum-lithium), Alnico, Duralumin, Hiduminium, Kryron Magnalium, Nambe, Scandium-aluminum, or Y alloy. The magnesium alloy may comprise Elektron, Magnox, or T-Mg—Al—Zn (Bergman phase) alloy.

The copper alloy may comprise Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may comprise Calamine brass, Chinese silver, Dutch metal, Gilding metal, Muntz metal, Pinchbeck, Prince's metal, or Tombac. The Bronze may comprise Aluminum bronze, Arsenical bronze, Bell metal, Florentine bronze, Guanin, Gunmetal, Glucydur, Phosphor bronze, Ormolu, or Speculum metal.

In some examples, the material (e.g., powder material) comprises a material wherein its constituents (e.g., atoms or molecules) readily lose their outer shell electrons, resulting in a free flowing cloud of electrons within their otherwise solid arrangement. In some examples the material is characterized in having high electrical conductivity, low electrical resistivity, high thermal conductivity, or high density (e.g., as measured at ambient temperature (e.g., R.T., or 20° C.)). The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁶ S/m. The symbol “*” designates the mathematical operation “times,” or “multiplied by.” The high electrical conductivity can be any value between the afore-mentioned electrical conductivity values (e.g., from about 1*10⁵ S/m to about 1*10⁶ S/m). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the afore-mentioned electrical resistivity values (e.g., from about 1×10⁻⁵ Ω*m to about 1×10⁻⁸ Ω*m). The high thermal conductivity may be at least about 20 Watts per meters times degrees Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the afore-mentioned thermal conductivity values (e.g., from about 20 W/mK to about 1000 W/mK). The high density may be at least about 1.5 grams per cubic centimeter (g/cm 3), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore-mentioned density values (e.g., from about 1 g/cm³ to about 25 g/cm³).

A metallic material (e.g., elemental metal or metal alloy) can comprise small amounts of non-metallic materials, such as, for example, oxygen, sulfur, or nitrogen. In some cases, the metallic material can comprise the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (on the basis of weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (on the basis of weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

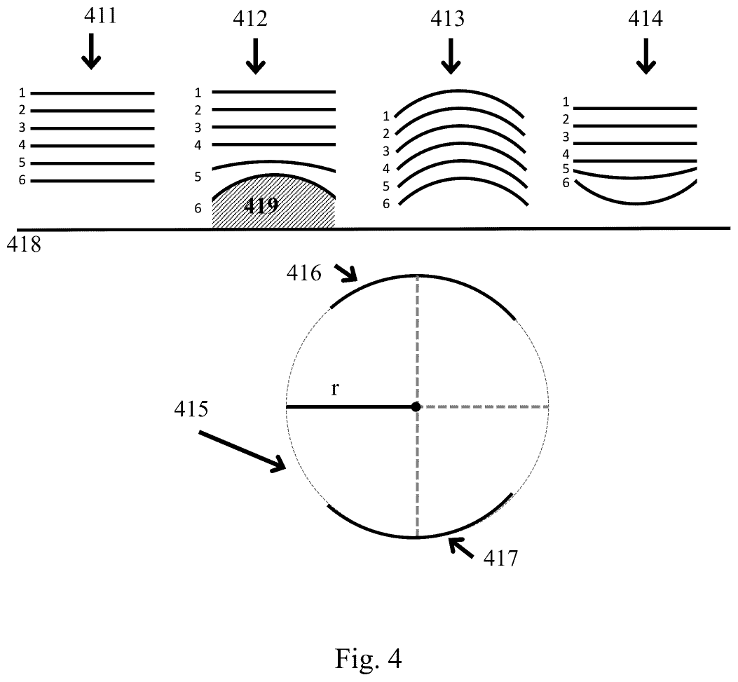

The one or more layers within the 3D object may be substantially planar (e.g., flat). The planarity of the layer may be substantially uniform. The height of the layer at a particular position may be compared to an average plane. An average plane may be defined by a least squares planar fit of the top-most part of the surface of the layer of hardened material. An average plane may be a plane calculated by averaging the material height at each point on the top surface of the layer of hardened material. The deviation from any point at the surface of the planar layer of hardened material may be at most 20% 15%, 10%, 5%, 3%, 1%, or 0.5% of the height (e.g., thickness) of the layer of hardened material. The substantially planar one or more layers may have a large radius of curvature. FIG. 4 shows an example of a vertical cross section of a 3D object 412 comprising planar layers (layers numbers 1-4) and non-planar layers (e.g., layers numbers 5-6) that have a radius of curvature. FIGS. 4, 416 and 417 are super-positions of curved layer on a circle 415 having a radius of curvature “r.” The one or more layers may have a radius of curvature equal to the radius of curvature of the layer surface. The radius of curvature may equal infinity (e.g., when the layer is flat). The radius of curvature of the layer surface (e.g., all the layers of the 3D object) may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 3 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The radius of curvature of the layer surface (e.g., all the layers of the 3D object) may have any value between any of the afore-mentioned values of the radius of curvature (e.g., from about 10 cm to about 90 m, from about 50 cm to about 10 m, from about 5 cm to about 1 m, from about 50 cm to about 5 m, from about 5 cm to infinity, or from about 40 cm to about 50 m). In some embodiments, a layer with an infinite radius of curvature is a layer that is planar. In some examples, the one or more layers may be included in a planar section of the 3D object, or may be a planar 3D object (e.g., a flat plane, or 3D plane). In some instances, part of at least one layer within the 3D object may have any of the radii of curvature mentioned herein, which will designate the radius of curvature of that layer portion. The 3D object may comprise a hanging structure. The hanging structure may be a plane like structure (referred to herein as “three dimensional plane,” or “3D plane”). A 3D plane may have a relatively small width as opposed to a relatively large surface area. For example, the 3D plane may have a small height relative to a large horizontal plane. The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf. The 3D object may comprise a wire.

The 3D object may comprise a layering plane N of the layered structure. FIG. 7C shows an example of a 3D object having a layered structure, wherein 705 shows an example of a side view of a plane, wherein 701 shows an example of a layering plane. The layering plane may be the average or mean plane of a layer of hardened material (as part of the 3D object). The 3D object may comprise points X and Y, which reside on the surface of the 3D object, wherein X is spaced apart from Y by at least about 10.5 millimeters or more. FIG. 5 shows an example of points X and Y on the surface of a 3D object. In some embodiments, X is spaced apart from Y by the auxiliary feature spacing distance. A sphere of radius XY that is centered at X lacks one or more auxiliary supports or one or more auxiliary support marks that are indicative of a presence or removal of the one or more auxiliary support features. In some embodiments, Y is spaced apart from X by at least about 10.5 millimeters or more. An acute angle between the straight line XY and the direction normal to N may be from about 45 degrees to about 90 degrees. The acute angle between the straight line XY and the direction normal to the layering plane may be of the value of the acute angle alpha. When the angle between the straight line XY and the direction of normal to N is greater than 90 degrees, one can consider the complementary acute angle. The layer structure may comprise any material(s) used for 3D printing. Each layer of the 3D structure can be made of a single material or of multiple materials. Sometimes one part of the layer may comprise one material, and another part may comprise a second material different than the first material. A layer of the 3D object may be composed of a composite material. The 3D object may be composed of a composite material. The 3D object may comprise a functionally graded material.

In some embodiments, the generated 3D object may be generated with the accuracy of at least about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm with respect to a model of the 3D object (e.g., the desired 3D object). With respect to a model of the 3D object, the generated 3D object may be generated with the accuracy of any accuracy value between the afore-mentioned values (e.g., from about 5 μm to about 100 μm, from about 15 μm to about 35 μm, from about 100 μm to about 1500 μm, from about 5 μm to about 1500 μm, or from about 400 μm to about 600 μm).

The hardened layer of transformed material may deform. The deformation may cause a horizontal (e.g., height) and/or lateral (e.g., width and/or length) deviation from a desired uniformly planar layer of hardened material. The horizontal and/or lateral deviation of the planar surface of the layer of hardened material may be at most about 100 μm, 90 μm, 80 μm, 70 μm, 60 μm, 50 μm, 40 μm, 30 μm, 20 μm, 10 μm, or 5 μm. The horizontal and/or lateral deviation of the planar surface of the layer of hardened material may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dip. The resolution of the 3D object may be any value between the afore-mentioned values (e.g., from 100 dpi to 4800 dpi, from 300 dpi to 2400 dpi, or from 600 dpi to 4800 dpi). A dot may be a melt pool. A dot may be a step. A dot may be a height of the layer of hardened material. A step may have a value of at most the height of the layer of hardened material.

The vertical (e.g., height) uniformity of a layer of hardened material may persist across a portion of the layer surface that has a FLS (e.g., a width and/or a length) of at least about 1 mm, 2 mm, 3 mm, 4 mm, 5 mm, or 10 mm, have a height deviation of at least about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm, 70 μm, 60 μm, 50 μm, 40 μm, 30 μm, 20 μm, or 10 μm. The height uniformity of a layer of hardened material may persist across a portion of the target surface that has a FLS (e.g., a width and/or a length) of most about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm, 70 μm, 60 μm, 50 μm, 40 μm, 30 μm, 20 μm, or 10 μm. The height uniformity of a layer of hardened material may persist across a portion of the target surface that has a FLS (e.g., a width and/or a length) of any value between the afore-mentioned width or length values (e.g., from about 10 mm to about 10 μm, from about 10 mm to about 100 μm, or from about 5 mm to about 500 μm). A target surface may be a layer of hardened material (e.g., as part of the 3D object).

Characteristics of the 3D object (e.g., hardened material) and/or any of its parts (e.g., layer of hardened material) can be measured by any of the following measurement methodologies. For example, the FLS values (e.g., width, height uniformity, auxiliary support space, an/d or radius of curvature) of the layer of the 3D object and any of its components (e.g., layer of hardened material) may be measured by any of the following measuring methodologies. The measurement methodologies may comprise a microscopy method (e.g., any microscopy method described herein). The measurement methodologies may comprise a coordinate measuring machine (CMM), measuring projector, vision measuring system, and/or a gauge. The gauge can be a gauge distometer (e.g., caliber). The gauge can be a go-no-go gauge. The measurement methodologies may comprise a caliber (e.g., vernier caliber), positive lens, interferometer, or laser (e.g., tracker). The measurement methodologies may comprise a contact or by a non-contact method. The measurement methodologies may comprise one or more sensors (e.g., optical sensors and/or metrological sensors). The measurement methodologies may comprise a metrological measurement device (e.g., using metrological sensor(s)). The measurements may comprise a motor encoder (e.g., rotary and/or linear). The measurement methodologies may comprise using an electromagnetic beam (e.g., visible or IR). The microscopy method may comprise ultrasound or nuclear magnetic resonance. The microscopy method may comprise optical microscopy. The microscopy method may comprise electromagnetic, electron, or proximal probe microscopy. The electron microscopy may comprise scanning, tunneling, X-ray photo-, or Auger electron microscopy. The electromagnetic microscopy may comprise confocal, stereoscope, or compound microscopy. The microscopy method may comprise an inverted or non-inverted microscope. The proximal probe microscopy may comprise atomic force, scanning tunneling microscopy, or any other microscopy method. The microscopy measurements may comprise using an image analysis system. The measurements may be conducted at ambient temperatures (e.g., R.T.), melting point temperature (e.g., of the powder material) or cryogenic temperatures.

The microstructures (e.g., of melt pools) of the 3D object may be measured by a microscopy method (e.g., any microscopy method described herein). The microstructures may be measured by a contact or by a non-contact method. The microstructures may be measured by using an electromagnetic beam (e.g., visible or IR). The microstructure measurements may comprise evaluating the dendritic arm spacing and/or the secondary dendritic arm spacing (e.g., using microscopy). The microscopy measurements may comprise an image analysis system. The measurements may be conducted at ambient temperatures (e.g., R.T.), melting point temperature (e.g., of the powder material) or cryogenic temperatures.

Various distances relating to the chamber can be measured using any of the following measurement techniques. Various distances within the chamber can be measured using any of the measurement techniques. For example, the gap distance (e.g., from the cooling member to the exposed surface of the powder bed) may be measured using any of the measurement techniques. The measurements techniques may comprise interferometry and/or confocal chromatic measurements. The measurements techniques may comprise at least one motor encoder (rotary, linear). The measurement techniques may comprise one or more sensors (e.g., optical sensors and/or metrological sensors). The measurement techniques may comprise at least one inductive sensor. The measurement techniques may include an electromagnetic beam (e.g., visible or IR). The measurements may be conducted at ambient temperatures (e.g., R.T.), melting point temperature (e.g., of the powder material) or cryogenic temperatures.

The methods described herein can provide surface uniformity across the exposed surface of the powder bed such that portions of the exposed surface that comprises the dispensed powder material, which are separated from one another by a distance of from about 1 mm to about 10 mm, have a vertical (e.g., height) deviation from about 100 μm to about 5 μm. The methods described herein may achieve a deviation from a planar uniformity of the layer of powder material in at least one plane (e.g., horizontal plane) of at most about 20%, 10%, 5%, 2%, 1% or 0.5%, as compared to the average or mean plane (e.g., horizontal plane) created at the exposed surface of the powder bed (e.g., top of a powder bed) and/or as compared to the platform (e.g., building platform). The vertical deviation can be measured by using one or more sensors (e.g., optical sensors).

The 3D object can have various surface roughness profiles, which may be suitable for various applications. The surface roughness may be the deviations in the direction of the normal vector of a real surface, from its ideal form. The surface roughness may be measured as the arithmetic average of the roughness profile (hereinafter “Ra”). The 3D object can have a Ra value of at least about 300 μm, 200 μm, 100 μm, 75 μm, 50 μm, 45 μm, 40 μm, 35 μm, 30 μm, 25 μm, 20 μm, 15 μm, 10 μm, 7 μm, 5 μm, 5 μm, 1 μm, 500 nm, 400 nm, 300 nm, 200 nm, 100 nm, 50 nm, 40 nm, or 30 nm. The formed object can have a Ra value of at most about 300 μm, 200 μm, 100 μm, 75 μm, 50 μm, 45 μm, 40 μm, 35 μm, 30 μm, 25 μm, 20 μm, 15 μm, 10 μm, 7 μm, 5 μm, 5 μm, 1 μm, 500 nm, 400 nm, 300 nm, 200 nm, 100 nm, 50 nm, 40 nm, or 30 nm. The 3D object can have a Ra value between any of the afore-mentioned Ra values (e.g., from about 300 μm to about 50 μm, from about 50 μm to about 5 μm, from about 5 μm to about 300 nm, from about 300 nm to about 30 nm, or from about 300 μm to about 30 nm). The Ra values may be measured by a contact or by a non-contact method. The Ra values may be measured by a roughness tester and/or by a microscopy method (e.g., any microscopy method described herein). The measurements may be conducted at ambient temperatures (e.g., R.T.), melting point temperature (e.g., of the powder material) or cryogenic temperatures. The roughness may be measured by a contact or by a non-contact method. The roughness measurement may comprise one or more sensors (e.g., optical sensors). The roughness measurement may comprise using a metrological measurement device (e.g., using metrological sensor(s)). The roughness may be measured using an electromagnetic beam (e.g., visible or IR).

The 3D object may be composed of successive layers of solid material that originated from a transformed material, and subsequently hardened. For example, the 3D object may be composed of successive layers of solid material that originated from an at least partially molten material, and subsequently solidified. The successive layers of solid material may correspond to successive cross sections of a desired 3D object. The transformed powder material may connect (e.g., weld) to a hardened (e.g., solidified) material. The hardened material may reside within the same layer as the transformed material, or in another layer (e.g., a previous layer). In some examples, the hardened material comprises disconnected parts of the 3D object, that are subsequently connected by newly transformed material. Transforming may comprise fusing, binding or otherwise connecting the powder material (e.g., connecting the particulate material). Fusing may comprise sintering or melting.

A cross section (e.g., vertical cross section) of the generated (i.e., formed) 3D object may reveal a microstructure or a grain structure indicative of a layered deposition. Without wishing to be bound to theory, the microstructure or grain structure may arise due to the solidification of transformed (e.g., powder) material that is typical to and/or indicative of the 3D printing method. For example, a cross section may reveal a microstructure resembling ripples or waves that are indicative of solidified melt pools that may be formed during the 3D printing process. FIGS. 7A and 7B show examples of successive melt pool in a 3D object that are arranged in layers.

The repetitive layered structure of the solidified melt pools relative to an external plane of the 3D object may reveal the orientation at which the part was printed, since the deposition of the melt pools is in a substantially horizontal plane. FIG. 7C shows examples of 3D objects that are formed by layerwise deposition, which layer orientation with respect to an external plane of the 3D object reveals the orientation of the object during its 3D printing. For example, a 3D object having an external plane 701 was formed in a manner that both the external plane 701 and the layers of hardened material (e.g., 705) were formed substantially parallel to the platform 703. For example, a 3D object having an external plane 702 was formed in a way that the external plane 702 formed an angle with the platform 703, whereas the layers of hardened material (e.g., 706) were formed substantially parallel to the platform 703. The 3D object having an external plane 704 shows an example of a 3D object that was generated such that its external plane 704 formed an angle (e.g., alpha) with the platform 703; which printed 3D object was placed on the platform 703 after its generation was complete; whereas during its generation (e.g., build), the layers of hardened material (e.g., 707) were oriented substantially parallel to the platform 703.

The cross section of the 3D object may reveal a substantially repetitive microstructure or grain structure. The microstructure or grain structure may comprise substantially repetitive variations in material composition, grain orientation, material density, degree of compound segregation or of element segregation to grain boundaries, material phase, metallurgical phase, crystal phase, crystal structure, material porosity, or any combination thereof. The microstructure or grain structure may comprise substantially repetitive solidification of layered melt pools. (e.g., FIGS. 7A-7B). The substantially repetitive microstructure may have an average height of at least about 0.5 μm, 1 μm, 5 μm, 7 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, 500 μm, or 1000 μm. The substantially repetitive microstructure may have an average height of at most about 1000 μm, 500 μm, 450 μm, 400 μm, 350 μm, 300 μm, 250 μm, 200 μm, 150 μm, 100 μm, 90 μm, 80 μm, 70 μm, 60 μm, 50 μm, 40 μm, 30 μm, 20 μm, or 10 μm. The substantially repetitive microstructure may have an average height of any value between the afore-mentioned values (e.g., from about 0.5 μm to about 1000 μm, from about 15 μm to about 50 μm, from about 5 μm to about 150 μm, from about 20 μm to about 100 μm, or from about 10 μm to about 80 μm). The microstructure (e.g., melt pool) height may correspond to the height of a layer of hardened material. The layer height is can be seen in the example in FIG. 7C, that shows examples of gaps between layering planes. For example a gap distance between the layering plane 705 and the layering plane just above or just below it).

The 3D object may comprise a reduced amount of constraints (e.g., supports). The 3D object may comprise less constraints. The reduced amount may be relative to prevailing 3D printing methodologies in the art (e.g., respective methodologies). The 3D object may be less constraint (e.g., relative to prevailing 3D printing methodologies in the art). The 3D object may be constraintless (e.g., supportless).

The powder material within the powder bed can be configured to provide support to the 3D object. The powder material may be a powder. The powder may be flowable. The powder in any of the disposed layers in the powder bed may be flowable. Before, during and/or at the end of the 3D printing process, the powder material that did not transform may be flowable. The powder that did not transform to form the 3D object (or a portion thereof) may be referred to as a “remainder.” In some instances, a low flowability powder can be capable of supporting a 3D object better than a high flowability powder. A low flowability powder can be achieved inter alia with a powder composed of relatively small particles, with particles of non-uniform size or with particles that attract each other. The powder may be of low, medium, or high flowability. The powder material may have compressibility of at least about 1%, 2%, 3%, 4%, 5%, 6%, 7%, 8%, 9%, or 10% in response to an applied force of 15 kilo Pascals (kPa). The powder may have a compressibility of at most about 9%, 8%, 7%, 6%, 5%, 4.5%, 4.0%, 3.5%, 3.0%, 2.5%, 2.0%, 1.5%, 1.0%, or 0.5% in response to an applied force of 15 kilo Pascals (kPa). The powder may have basic flow energy of at least about 100 milli-Joule (mJ), 200 mJ, 300 mJ, 400 mJ, 450 mJ, 500 mJ, 550 mJ, 600 mJ, 650 mJ, 700 mJ, 750 mJ, 800 mJ, or 900 mJ. The powder may have basic flow energy of at most about 200 mJ, 300 mJ, 400 mJ, 450 mJ, 500 mJ, 550 mJ, 600 mJ, 650 mJ, 700 mJ, 750 mJ, 800 mJ, 900 mJ, or 1000 mJ. The powder may have basic flow energy in between the above listed values of basic flow energy values (e.g., from about 100 mj to about 1000 mJ, from about 100 mj to about 600 mJ, or from about 500 mj to about 1000 mJ). The powder may have a specific energy of at least about 1.0 milli-Joule per gram (mJ/g), 1.5 mJ/g, 2.0 mJ/g, 2.5 mJ/g, 3.0 mJ/g, 3.5 mJ/g, 4.0 mJ/g, 4.5 mJ/g, or 5.0 mJ/g. The powder may have a specific energy of at most 5.0 mJ/g, 4.5 mJ/g, 4.0 mJ/g, 3.5 mJ/g, 3.0 mJ/g, 2.5 mJ/g, 2.0 mJ/g, 1.5 mJ/g, or 1.0 mJ/g. The powder may have a specific energy in between any of the above values of specific energy (e.g., from about 1.0 mJ/g to about 5.0 mJ/g, from about 3.0 mJ/g to about 5 mJ/g, or from about 1.0 mJ/g to about 3.5 mJ/g).

During its formation (e.g., layerwise generation), the 3D object can have one or more auxiliary features. During its formation (e.g., layerwise generation), the 3D object can be devoid of any auxiliary features. The auxiliary feature(s) can be supported by the material (e.g., powder) bed and/or by the enclosure. In some instances, the auxiliary supports may connect to the enclosure (e.g., the platform). Connected may comprise anchored. In some instances, the auxiliary supports may not connect (e.g., be anchored) to the enclosure (e.g., the platform). For example, the auxiliary supports may contact (e.g., touch) and not connect (e.g., be anchored) to the enclosure (e.g., the platform). The 3D object comprising one or more auxiliary supports, or devoid of auxiliary supports may be suspended (e.g., float) in the powder bed. The floating 3D object (with or without the one or more auxiliary supports) may contact or not contact the enclosure.

The term “auxiliary features,” as used herein, generally refers to features that are part of a printed 3D object, but are not part of the desired, intended, designed, ordered, modeled, or final 3D object. Auxiliary feature(s) (e.g., auxiliary supports) may provide structural support during and/or subsequent to the formation of the 3D object. Auxiliary features may enable the removal of energy from the 3D object while it is being formed. Examples of auxiliary features comprise the platform (e.g., building platform and/or base), heat fins, wires, anchors, handles, supports, pillars, columns, frame, footing, scaffold, flange, projection, protrusion, mold (a.k.a. mould), or other stabilization features. In some instances, the auxiliary support is a scaffold that encloses the 3D object or part thereof. The scaffold may comprise lightly sintered or lightly fused powder material. The 3D object can have auxiliary features that can be supported by the powder bed and not touch the base, substrate, container accommodating the powder bed, and/or the bottom of the enclosure. The 3D part (e.g., 3D object) in a complete or partially formed state can be completely supported by the powder bed (e.g., without being anchored to the substrate, base, container accommodating the powder bed, or enclosure). The 3D object in a complete or partially formed state can be (completely) supported by the powder bed (e.g., without touching anything except the powder bed). The 3D object in a complete or partially formed state can be suspended in the powder bed without resting on any additional support structures. In some cases, the 3D object in a complete or partially formed (i.e., nascent) state can freely float (e.g., anchorless) in the powder bed. Suspended may be floating, disconnected, anchorless, detached, non-adhered, or free. In some examples, the 3D object may not be anchored (e.g., connected) to at least a part of the enclosure (e.g., during formation of the 3D object, and/or during formation of at least one layer of the 3D object). The enclosure may comprise a platform and/or wall that define the powder bed. The 3D object may not touch and/or not contact enclosure (e.g., during formation of at least one layer of the 3D object). The 3D object be suspended (e.g., float) in the powder bed. The scaffold may comprise a continuously sintered (e.g., lightly sintered) structure that is at most 1 millimeter (mm), 2 mm, 5 mm or 10 mm. The scaffold may comprise a continuously sintered structure that is at least 1 millimeter (mm), 2 mm, 5 mm or 10 mm. The scaffold may comprise a continuously sintered structure having dimensions between any of the afore-mentioned dimensions (e.g., from about 1 mm to about 10 mm, or from about 1 mm to about 5 mm). In some examples, the 3D object may be printed without a supporting scaffold. The supporting scaffold may engulf at least a portion of the 3D object (e.g., the entire 3D object). For example, a supporting scaffold that floats in the powder bed, or that is connected to at least a portion of the enclosure.

The printed 3D object may be printed without the use of auxiliary features. The printed 3D object may be printed using a reduced amount of auxiliary features, and/or printed using spaced apart auxiliary features. In some embodiments, the printed 3D object may be devoid of (one or more) auxiliary support features or auxiliary support feature marks that are indicative of a presence or removal of the auxiliary support feature(s). The 3D object may be devoid of one or more auxiliary support features and of one or more marks of an auxiliary feature (including a base structure) that was removed (e.g., subsequent to, or contemporaneous with, the generation of the 3D object). The printed 3D object may comprise a single auxiliary and/or a single auxiliary support mark. The single auxiliary feature (e.g., auxiliary support or auxiliary structure) may be a platform (e.g., a building platform such as a base or substrate), or a mold. The auxiliary support may be adhered to the platform or mold. The 3D object may comprise marks belonging to one or more auxiliary structures. The 3D object may comprise two or more marks belonging to auxiliary feature(s). The 3D object may be devoid of marks pertaining to at least one auxiliary support. The 3D object may be devoid of one or more auxiliary support. The mark may comprise variation in grain orientation, variation in layering orientation, layering thickness, material density, the degree of compound segregation to grain boundaries, material porosity, the degree of element segregation to grain boundaries, material phase, metallurgical phase, crystal phase, or crystal structure; wherein the variation may not have been created by the geometry of the 3D object alone, and may thus be indicative of a prior existing auxiliary support that was removed. The variation may be forced upon the generated 3D object by the geometry of the support. In some instances, the 3D structure of the printed object may be forced by the auxiliary support(s) (e.g., by a mold). For example, a mark may be a point of discontinuity that is not explained by the geometry of the 3D object, which does not include any auxiliary support(s). A mark may be a surface feature that cannot be explained by the geometry of a 3D object, which does not include any auxiliary support(s) (e.g., a mold). The two or more auxiliary features or auxiliary support feature marks may be spaced apart by a spacing distance of at least 1.5 millimeters (mm), 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The two or more auxiliary support features or auxiliary support feature marks may be spaced apart by a spacing distance of any value between the afore-mentioned auxiliary support space values (e.g., from 1.5 mm to 500 mm, from 2 mm to 100 mm, from 15 mm to 50 mm, or from 45 mm to 200 mm). Collectively referred to herein as the “auxiliary feature spacing distance.”

The 3D object may comprise a layered structure indicative of 3D printing process that is devoid of one or more auxiliary support features or one or more auxiliary support feature marks that are indicative of a presence or removal of the one or more auxiliary support features. The 3D object may comprise a layered structure indicative of 3D printing process, which includes one, two, or more auxiliary support marks. The auxiliary support structure may comprise a supporting scaffold. The supporting scaffold may comprise a dense arrangement (e.g., array) of support structures. The support(s) or support mark(s) can stream from or appear on the surface of the 3D object. The auxiliary supports or support marks can stem from or appear on an external surface and/or on an internal surface (e.g., a cavity within the 3D object). The layered 3D structure can have a layering plane. In one example, two auxiliary support features or auxiliary support feature marks present in the 3D object may be spaced apart by the auxiliary feature spacing distance.

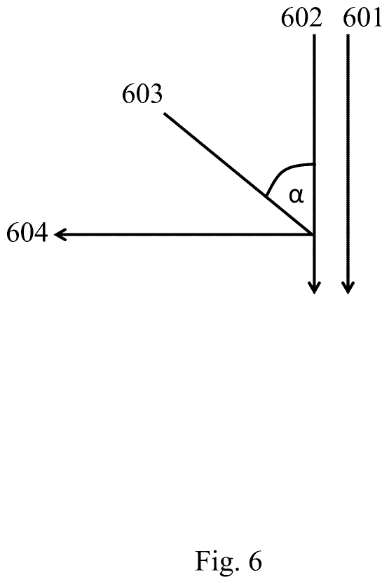

FIG. 6 shows an example of a coordinate system. Line 604 represents a vertical cross section of a layering plane. Line 603 represents the straight line connecting the two auxiliary supports or auxiliary supports or support marks. Line 602 represent the normal to the layering plane. Line 601 represents the direction of the gravitational field. The acute (i.e., sharp) angle alpha between the straight line connecting the two auxiliary supports or auxiliary support marks and the direction of normal to the layering plane may be at least about 45 degrees (°), 50°, 55°, 60°, 65°, 70°, 75°, 80°, or 85°. The acute angle alpha between the straight line connecting the two auxiliary supports or auxiliary support marks and the direction of normal to the layering plane may be at most about 90°, 85°, 80°, 75°, 70°, 65°, 60°, 55°, 50°, or 45°. The acute angle alpha between the straight line connecting the two auxiliary supports or auxiliary support marks and the direction of normal to the layering plane may be any angle range between the afore-mentioned angles (e.g., from about 45 degrees (°), to about 90°, from about 60° to about 90°, from about 75° to about 90°, from about 80° to about 90°, or from about 85° to about 90°). The acute angle alpha between the straight line connecting the two auxiliary supports or auxiliary support marks and the direction normal to the layering plane may from about 87° to about 90°. An example of a layering plane can be seen in FIG. 4 showing a vertical cross section of a 3D object 411 that comprises layers 1 to 6, each of which are substantially planar. In the schematic example in FIG. 4, the layering plane of the layers can be the layer. For example, layer 1 could correspond to both the layer and the layering plane of layer 1. When the layer is not planar (e.g., FIG. 4, layer 5 of 3D object 412), the layering plane would be the average plane of the layer. The two auxiliary supports or auxiliary support feature marks can be on the same surface (e.g., external surface of the 3D object). The same surface can be an external surface or an internal surface (e.g., a surface of a cavity within the 3D object). When the angle between the shortest straight line connecting the two auxiliary supports or auxiliary support marks and the direction of normal to the layering plane is greater than 90 degrees, one can consider the complementary acute angle. In some embodiments, any two auxiliary supports or auxiliary support marks are spaced apart by at least about 10.5 millimeters or more. In some embodiments, any two auxiliary supports or auxiliary support marks are spaced apart by at least about 40.5 millimeters or more. In some embodiments, any two auxiliary supports or auxiliary support marks are spaced apart by the auxiliary feature spacing distance. FIG. 7C shows an example of a 3D object comprising an exposed surface 701 that was formed with layers of hardened material (e.g., having layering plane 705) that are substantially parallel to the platform 703. FIG. 7C shows an example of a 3D object comprising an exposed surface 702 that was formed with layers of hardened material (e.g., having layering plane 706) that are substantially parallel to the platform 703 resulting in a tilted 3D object (e.g., box). The 3D object that was formed as a tiled object, is shown subsequent to its generation, lying on a surface 709 as a 3D object having an exposed surface 704 and layers of hardened material (e.g., having layering plane 707) having a normal 708 to the layering plane that forms acute angle alpha with the exposed surface 704 of the 3D object. FIGS. 7A and 7B show 3D objects comprising layers of solidified melt pools that are arranged in layers having layering planes (e.g., 720).

The 3D object can be formed without one or more auxiliary features and/or without contacting a platform (e.g., a base, a substrate, or a bottom of an enclosure). The one or more auxiliary features (which may include a base support) can be used to hold or restrain the 3D object during formation. In some cases, auxiliary features can be used to anchor and/or hold a 3D object or a portion of a 3D object in a powder bed (e.g., with or without contacting the enclosure, or with or without connecting to the enclosure). The one or more auxiliary features can be specific to a 3D object and can increase the time, energy, material and/or cost required to form the 3D object. The one or more auxiliary features can be removed prior to use or distribution of the 3D object. The longest dimension of a cross-section of an auxiliary feature can be at most about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension (e.g., FLS) of a cross-section of an auxiliary feature can be at least about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension of a cross-section of an auxiliary feature can be any value between the above-mentioned values (e.g., from about 50 nm to about 300 mm, from about 5 μm to about 10 mm, from about 50 nm to about 10 mm, or from about 5 mm to about 300 mm). Eliminating the need for auxiliary features can decrease the time, energy, material, and/or cost associated with generating the 3D object (e.g., 3D part). In some examples, the 3D object may be formed with auxiliary features. In some examples, the 3D object may be formed while connecting to the container accommodating the powder bed (e.g., side(s) and/or bottom of the container).

In some examples, the diminished number of auxiliary supports or lack of one or more auxiliary supports, will provide a 3D printing process that requires a smaller amount of material, energy, material, and/or cost as compared to commercially available 3D printing processes. In some examples, the diminished number of auxiliary supports or lack of one or more auxiliary supports, will provide a 3D printing process that produces a smaller amount of material waste as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the aforesaid values (e.g., from about 1.1 to about 10, or from about 1.5 to about 5).

At least a portion of the 3D object can be vertically displaced (e.g., sink) in the powder bed. At least a portion of the 3D object can be surrounded by powder material within the powder bed (e.g., submerged). At least a portion of the 3D object can rest in the powder material without substantial vertical movement (e.g., displacement). Lack of substantial vertical displacement can amount to a vertical movement (e.g., sinking) of at most about 40%, 20%, 10%, 5%, or 1% of the layer thickness. Lack of substantial sinking can amount to at most about 100 μm, 30 μm, 10 μm, 5 μm, or 1 μm. At least a portion of the 3D object can rest in the powder material without substantial movement (e.g., horizontal, vertical, and/or angular). Lack of substantial movement can amount to a movement of at most 100 μm, 30 μm, 10 μm, 5 μm, or 1 μm. The 3D object can rest on the substrate when the 3D object is vertically displaced (e.g., sunk) or submerged in the powder bed.

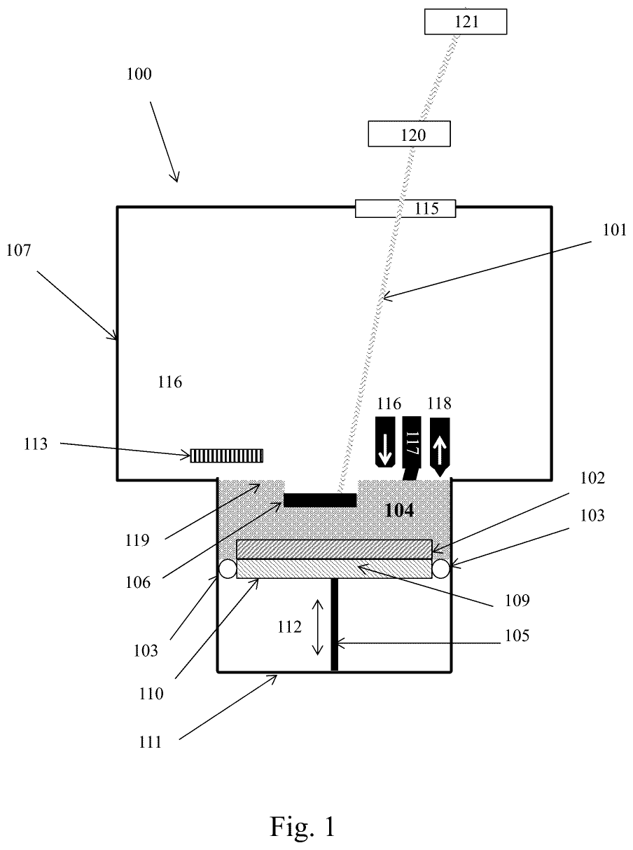

FIG. 1 depicts an example of a system that can be used to generate a 3D object using a 3D printing process disclosed herein. The system can include an enclosure (e.g., a chamber 107). At least a fraction of the components in the system can be enclosed in the chamber. At least a fraction of the chamber can be filled with a gas to create a gaseous environment (i.e., an atmosphere). The gas can be an inert gas (e.g., Argon, Neon, Helium, Nitrogen). The chamber can be filled with another gas or mixture of gases. The gas can be a non-reactive gas (e.g., an inert gas). The gaseous environment can comprise argon, nitrogen, helium, neon, krypton, xenon, hydrogen, carbon monoxide, or carbon dioxide. The pressure in the chamber can be at least 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, or 1000 bar. The pressure in the chamber can be at least about 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at most about 10⁻⁷ Torr, 10⁻⁶ Torr, 10⁻⁵ Torr, or 10⁻⁴ Torr, 10⁻³ Torr, 10⁻² Torr, 10⁻¹ Torr, 1 Torr, 10 Torr, 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at a range between any of the afore-mentioned pressure values (e.g., from about 10⁻⁷ Torr to about 1200 Torr, from about 10⁻⁷ Torr to about 1 Torr, from about 1 Torr to about 1200 Torr, or from about 10⁻² Torr to about 10 Torr). The pressure can be measured by a pressure gauge. The pressure can be measured at ambient temperature (e.g., R.T.), cryogentic temperature, or at the temperature of the melting point of the powder material. In some cases, the pressure in the chamber can be standard atmospheric pressure. In some cases, the pressure in the chamber can be ambient pressure (i.e., neutral pressure). In some examples, the chamber can be under vacuum pressure. In some examples, the chamber can be under a positive pressure (i.e., above ambient pressure).

The chamber can comprise two or more gaseous layers. The gaseous layers can be separated by molecular weight or density such that a first gas with a first molecular weight or density is located in a first region, and a second gas with a second molecular weight or density is located in a second region of the chamber above or below the first region. The first molecular weight or density may be smaller than the second molecular weight or density. The first molecular weight or density may be larger than the second molecular weight or density. The gaseous layers can be separated by a temperature difference. The first gas can be in a lower region of the chamber relative to the second gas. The second gas and the first gas can be in adjacent locations. The second gas can be on top of, over, and/or above the first gas. In some cases, the first gas can be argon and the second gas can be helium. The molecular weight or density of the first gas can be at least about 1.5*, 2*, 3*, 4*, 5*, 10*, 15*, 20*, 25*, 30*, 35*, 40*, 50*, 55*, 60*, 70*, 75*, 80*, 90*, 100*, 200*, 300*, 400*, or 500* larger or greater than the molecular weight or density of the second gas (e.g., measured at ambient temperature). The molecular weight of the first gas can be higher than the molecular weight of air. The molecular weight or density of the first gas can be higher than the molecular weight or density of oxygen gas (e.g., O₂). The molecular weight or density of the first gas can be higher than the molecular weight or density of nitrogen gas (e.g., N₂). The molecular weight or density of the first gas may be lower than that of oxygen gas and/or nitrogen gas.

The first gas with the relatively higher molecular weight or density can fill a region of the system where at least a fraction of the powder material is stored. The first gas with the relatively higher molecular weight or density can fill a region of the system and/or apparatus where the 3D object is formed. Alternatively, the second gas with the relatively lower molecular weight or density can fill a region of the system and/or apparatus where the 3D object is formed. The material layer can be supported on a platform. The platform may comprise a substrate (e.g., 109). The substrate can have a circular, rectangular, square, or irregularly shaped cross-section. The platform may comprise a base disposed above the substrate. The platform may comprise a base (e.g., 102) disposed between the substrate and a material layer (or a space to be occupied by a material layer). A thermal control unit (e.g., a cooling member such as a heat sink or a cooling plate, or a heating plate 113) can be provided inside of the region where the 3D object is formed or adjacent to (e.g., above) the region where the 3D object is formed. The thermal control unit may comprise a thermostat. Additionally, or alternatively, the thermal control unit can be provided outside of the region where the 3D object is formed (e.g., at a predetermined distance). In some cases, the thermal control unit can form at least one section of a boundary region where the 3D object is formed (e.g., the container accommodating the powder bed).

The concentration of oxygen and/or humidity in the enclosure (e.g., chamber) can be minimized (e.g., below a predetermined threshold value). The gas composition of the chamber may contain a level of oxygen and/or humidity that is at most about 100 parts per billion (ppb), 10 ppb, 1 ppb, 0.1 ppb, 0.01 ppb, 0.001 ppb, 100 parts per million (ppm), 10 ppm, 1 ppm, 0.1 ppm, 0.01 ppm, or 0.001 ppm. The gas composition of the chamber can contain an oxygen and/or humidity level between any of the afore-mentioned values (e.g., from about 100 ppb to about 0.001 ppm, from about 1 ppb to about 0.01 ppm, or from about 1 ppm to about 0.1 ppm). The gas composition may be measures by one or more sensors (e.g., an oxygen and/or humidity sensor). The chamber can be opened at the completion of a formation of a 3D object. When the chamber is opened, ambient air containing oxygen and/or humidity can enter the chamber. Exposure of one or more components inside the chamber to air can be reduced by, for example, flowing an inert gas while the chamber is open (e.g., to prevent entry of ambient air), or by flowing a heavy gas (e.g., argon) that rests on the surface of the powder bed. In some cases, components that absorb oxygen and/or humidity on to their surface(s) can be sealed while the enclosure (e.g., chamber) is open (e.g., to the ambient environment).

The chamber can be configured such that gas inside of the chamber has a relatively low leak rate from the chamber to an environment outside of the chamber. In some cases, the leak rate can be at most about 100 milliTorr/minute (mTorr/min), 50 mTorr/min, 25 mTorr/min, 15 mTorr/min, 10 mTorr/min, 5 mTorr/min, 1 mTorr/min, 0.5 mTorr/min, 0.1 mTorr/min, 0.05 mTorr/min, 0.01 mTorr/min, 0.005 mTorr/min, 0.001 mTorr/min, 0.0005 mTorr/min, or 0.0001 mTorr/min. The leak rate may be between any of the afore-mentioned leak rates (e.g., from about 0.0001 mTorr/min to about, 100 mTorr/min, from about 1 mTorr/min to about, 100 mTorr/min, or from about 1 mTorr/min to about, 100 mTorr/min). The leak rate may be measured by one or more pressure gauges and/or sensors (e.g., at ambient temperature). The enclosure can be sealed such that the leak rate of gas from inside the chamber to an environment outside of the chamber is low (e.g., below a certain level). The seals can comprise O-rings, rubber seals, metal seals, load-locks, or bellows on a piston. In some cases, the chamber can have a controller configured to detect leaks above a specified leak rate (e.g., by using at least one sensor). The sensor may be coupled to a controller. In some instances, the controller is able to identify and/or control (e.g., direct and/or regulate). For example, the controller may be able to identify a leak by detecting a decrease in pressure in side of the chamber over a given time interval.

One or more of the system components can be contained in the enclosure (e.g., chamber). The enclosure can include a reaction space that is suitable for introducing precursor to form a 3D object, such as pre-transformed (e.g., powder) material. The enclosure can contain the platform. In some cases, the enclosure can be a vacuum chamber, a positive pressure chamber, or an ambient pressure chamber. The enclosure can comprise a gaseous environment with a controlled pressure, temperature, and/or gas composition. The gas composition in the environment contained by the enclosure can comprise a substantially oxygen free environment. For example, the gas composition can contain at most about 100,000 parts per million (ppm), 10,000 ppm, 1000 ppm, 500 ppm, 400 ppm, 200 ppm, 100 ppm, 50 ppm, 10 ppm, 5 ppm, 1 ppm, 100,000 parts per billion (ppb), 10,000 ppb, 1000 ppb, 500 ppb, 400 ppb, 200 ppb, 100 ppb, 50 ppb, 10 ppb, 5 ppb, 1 ppb, 100,000 parts per trillion (ppt), 10,000 ppt, 1000 ppt, 500 ppt, 400 ppt, 200 ppt, 100 ppt, 50 ppt, 10 ppt, 5 ppt, or 1 ppt oxygen. The gas composition in the environment contained within the enclosure can comprise a substantially moisture (e.g., water) free environment. The gaseous environment can comprise at most about 100,000 ppm, 10,000 ppm, 1000 ppm, 500 ppm, 400 ppm, 200 ppm, 100 ppm, 50 ppm, 10 ppm, 5 ppm, 1 ppm, 100,000 ppb, 10,000 ppb, 1000 ppb, 500 ppb, 400 ppb, 200 ppb, 100 ppb, 50 ppb, 10 ppb, 5 ppb, 1 ppb, 100,000 ppt, 10,000 ppt, 1000 ppt, 500 ppt, 400 ppt, 200 ppt, 100 ppt, 50 ppt, 10 ppt, 5 ppt, or 1 ppt water. The gaseous environment can comprise a gas selected from the group consisting of argon, nitrogen, helium, neon, krypton, xenon, hydrogen, carbon monoxide, carbon dioxide, and oxygen. The gaseous environment can comprise air. The chamber pressure can be at least about 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 760 Torr, 1000 Torr, 1100 Torr, 2 bar, 3 bar, 4 bar, 5 bar, or 10 bar. The chamber pressure can be of any value between the afore-mentioned chamber pressure values (e.g., from about 10⁻⁷ Torr to about 10 bar, from about 10⁻⁷ Torr to about 1 bar, or from about 1 bar to about 10 bar). In some cases, the enclosure pressure can be standard atmospheric pressure. The gas can be an ultrahigh purity gas. The ultrahigh purity gas can be at least about 99%, 99.9%, 99.99%, or 99.999% pure. The gas may comprise less than about 2 ppm oxygen, less than about 3 ppm moisture, less than about 1 ppm hydrocarbons, or less than about 6 ppm nitrogen.

The enclosure can be maintained under vacuum or under an inert, dry, non-reactive and/or oxygen reduced (or otherwise controlled) atmosphere (e.g., a nitrogen (N₂), helium (He), or argon (Ar) atmosphere). In some examples, the enclosure is under vacuum. In some examples, the enclosure is under pressure of at most about 1 Torr, 10⁻³ Torr, 10⁻⁶ Torr, or 10⁻⁸ Torr. The atmosphere can be furnished by providing an inert, dry, non-reactive, and/or oxygen reduced gas (e.g., Ar). The atmosphere can be furnished by flowing the gas through the enclosure (e.g., chamber).

The system and/or apparatus components described herein can be adapted and configured to generate a 3D object. The 3D object can be generated through a 3D printing process. A first layer of powder material can be provided adjacent to a platform. A platform (e.g., base) can be a previously formed layer of the 3D object or any other surface upon which a layer or bed of powder material is spread, held, placed, adhered, attached, or supported. When the first layer of the 3D object is generated, the first material layer can be formed in the powder bed without a platform (e.g., base), without one or more auxiliary support features (e.g., rods), or without other supporting structure other than the powder material (e.g., within the powder bed). Subsequent layers can be formed such that at least one portion of the subsequent layer fused (e.g., melts or sinters) fuses, binds and/or otherwise connects to the at least a portion of a previously formed layer (or portion thereof). The at least a portion of the previously formed layer that can be transformed and optionally subsequently harden into a hardened material. The at least a portion of the previously formed layer that can acts as a platform (e.g., base) for formation of the 3D object. In some cases, the first layer comprises at least a portion of the platform (e.g., base). The powder material layer can comprise particles of homogeneous or heterogeneous size and/or shape.

The system and/or apparatus described herein may comprise at least one energy source (e.g., the transforming energy source generating the transforming energy beam). The energy source may be used to transform at least a portion of the powder bed into a transformed material (designated herein also as “transforming energy source”). The transforming energy source may project an energy beam (herein also “transforming energy beam”). The transforming energy beam may be any energy beam (e.g., scanning energy beam or energy flux) disclosed in provisional patent application Ser. No. 62/265,817, in Provisional Patent Application Ser. No. 62/317,070, in patent application Ser. No. 15/374,535, or in Patent Application serial number PCT/US16/66000, all of which are incorporated herein by reference in their entirety. The transforming energy source may be any energy source disclosed in provisional patent application Ser. No. 62/265,817, in Provisional Patent Application Ser. No. 62/317,070, in patent application Ser. No. 15/374,535, or in Patent Application serial number PCT/US16/66000, all of which are incorporated herein by reference in their entirety. The energy beam may travel (e.g., scan) along a path. The path may be predetermined (e.g., by the controller). The methods, systems and/or apparatuses may comprise at least a second energy source. The second energy source may generate a second energy (e.g., second energy beam). The first and/or second energy may transform at least a portion of the powder material in the powder bed to a transformed material. In some embodiments, the first and/or second energy source may heat but not transform at least a portion of the powder material in the powder bed. In some cases, the system can comprise 1, 2, 3, 4, 5, 6, 7, 8, 9, 10, 30, 100, 300, 1000 or more energy beams and/or sources. The system can comprise an array of energy sources (e.g., laser diode array). Alternatively, or additionally the surface, powder bed, 3D object (or part thereof), or any combination thereof may be heated by a heating mechanism. The heating mechanism may comprise dispersed energy beams. In some cases, the at least one energy source is a single (e.g., first) energy source.

An energy source can be a source configured to deliver energy to an area (e.g., a confined area). An energy source can deliver energy to the confined area through radiative heat transfer. The energy source can project energy (e.g., heat energy, and/or energy beam). The energy (e.g., beam) can interact with at least a portion of the material in the powder bed. The energy can heat the material in the powder bed before, during and/or after the powder material is being transformed (e.g., melted). The energy can heat at least a fraction of a 3D object at any point during formation of the 3D object. Alternatively or additionally, the powder bed may be heated by a heating mechanism projecting energy (e.g., radiative heat and/or energy beam). The energy may include an energy beam and/or dispersed energy (e.g., radiator or lamp). The energy may include radiative heat. The radiative heat may be projected by a dispersive energy source (e.g., a heating mechanism) comprising a lamp, a strip heater (e.g., mica strip heater, or any combination thereof), a heating rod (e.g., quartz rod), or a radiator (e.g., a panel radiator). The heating mechanism may comprise an inductance heater. The heating mechanism may comprise a resistor (e.g., variable resistor). The resistor may comprise a varistor or rheostat. A multiplicity of resistors may be configured in series, parallel, or any combination thereof. In some cases, the system can have a single (e.g., first) energy source that is used to transform at least a portion of the powder bed. An energy source can be a source configured to deliver energy to an area (e.g., a confined area). An energy source can deliver energy to the confined area through radiative heat transfer (e.g., as described herein).

The energy beam may include a radiation comprising an electromagnetic, or charged particle beam. The energy beam may include radiation comprising electromagnetic, electron, positron, proton, plasma, radical or ionic radiation. The electromagnetic beam may comprise microwave, infrared, ultraviolet, or visible radiation. The energy beam may include an electromagnetic energy beam, electron beam, particle beam, or ion beam. An ion beam may include a cation or an anion. A particle beam may include radicals. The electromagnetic beam may comprise a laser beam. The energy beam may comprise plasma. The energy source may include a laser source. The energy source may include an electron gun. The energy source may include an energy source capable of delivering energy to a point or to an area. In some embodiments the energy source can be a laser source. The laser source may comprise a CO₂, Nd:YAG, Neodymium (e.g., neodymium-glass), an Ytterbium, or an excimer laser. The energy source may include an energy source capable of delivering energy to a point or to an area. The energy source (e.g., transforming energy source) can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source can provide an energy beam having an energy density of at most about 50 J/cm², 100 J/cm², 200 J/cm², 300 J/cm², 400 J/cm², 500 J/cm², 600 J/cm², 700 J/cm², 800 J/cm², 1000 J/cm², 500 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source can provide an energy beam having an energy density of a value between the afore-mentioned values (e.g., from about 50 J/cm² to about 5000 J/cm², from about 200 J/cm² to about 1500 J/cm², from about 1500 J/cm² to about 2500 J/cm², from about 100 J/cm² to about 3000 J/cm², or from about 2500 J/cm² to about 5000 J/cm²). In an example, a laser can provide light energy at a peak wavelength of at least about 100 nanometer (nm), 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 750 nm, 500 nm, or 100 nm. The laser can provide light energy at a peak wavelength between any of the afore-mentioned peak wavelength values (e.g., from about 100 nm to about 2000 nm, from about 500 nm to about 1500 nm, or from about 1000 nm to about 1100 nm). The energy source generating the energy beam (e.g., laser) may have a power of at least about 0.5 Watt (W), 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy source generating the energy beam may have a power of at most about 0.5 W, 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500, 2000 W, 3000 W, or 4000 W. The energy source generating the energy beam may have a power between any of the afore-mentioned laser power values (e.g., from about 0.5 W to about 100 W, from about 1 W to about 10 W, from about 100 W to about 1000 W, or from about 1000 W to about 4000 W). The first energy source (e.g., producing the transforming energy beam) may have at least one of the characteristics of the second energy source.

An energy beam from the energy source(s) can be incident on, or be directed perpendicular to, the surface (also herein “target surface”). The target surface may be an exposed surface of the powder bed or an exposed surface of a hardened material. The hardened material may be a 3D object or a portion thereof. An energy beam from the energy source(s) can be directed at an acute angle within a value ranging from being parallel to being perpendicular with respect to the average or mean plane of the target surface. The energy beam can be directed onto a specified area of at least a portion of the target surface for a specified time period (e.g., dwell time). The material in target surface (e.g., powder material such as in a top surface of a powder bed) may absorb the energy from the energy beam and, and as a result, a localized region of at least the material at the surface, can increase in temperature. The energy beam can be moveable such that it can translate (e.g., horizontally, vertically, and/or in an angle). The energy source may be movable such that it can translate relative to the target surface. The energy beam(s) can be moved via a scanner (e.g., as disclosed herein). At least two (e.g., all) of the energy sources can be movable with the same scanner. A least two (e.g., all) of the energy beams can be movable with the same scanner. At least two of the energy source(s) and/or beam(s) can be translated independently of each other. In some cases, at least two of the energy source(s) and/or beam(s) can be translated at different rates (e.g., velocities). In some cases, at least two of the energy source(s) and/or beam(s) can be comprise at least one different characteristic. The characteristics may comprise wavelength, charge, power, amplitude, trajectory, footprint, cross-section, focus, intensity, energy, path, or hatching. The charge can be electrical and/or magnetic charge.

The energy source can be an array, or a matrix, of energy sources (e.g., laser diodes). Each of the energy sources in the array, or matrix, can be independently controlled (e.g., by a control mechanism) such that the energy beams can be turned off and on independently. At least a part of the energy sources (e.g., in the array or matrix) can be collectively controlled such that the at least two (e.g., all) of the energy sources can be turned off and on simultaneously. The energy per unit area or intensity of at least two energy sources in the matrix or array can be modulated independently (e.g., by a controller). At times, the energy per unit area or intensity of at least two (e.g., all) of the energy sources (e.g., in the matrix or array) can be modulated collectively (e.g., by a controller). The energy source can scan along the target surface by mechanical movement of the energy source(s), one or more adjustable reflective mirrors one or more polygon light scanners, or any combination or permutation thereof. The energy source(s) can project energy using a DLP modulator, a one-dimensional scanner, a two-dimensional scanner, or any combination thereof. The energy source(s) can be stationary. The powder bed (e.g., target surface) may translate vertically, horizontally, or in an angle (e.g., planar or compound). The translation may be effectuated using a scanner.

The energy source can be modulated. The energy beam emitted by the energy source can be modulated. The modulator can include amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an aucusto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam. The focus of the energy beam may be controlled (e.g., modulated).

The energy source and/or beam can be moveable such that it can translate relative to the powder bed (e.g., target surface). In some instances, the energy source may be movable such that it can translate across (e.g., laterally) the exposed (e.g., top) surface of the powder bed. The energy beam(s) and/or source(s) can be moved via a scanner. The scanner may comprise a galvanometer scanner, a polygon, a mechanical stage (e.g., X-Y stage), a piezoelectric device, gimble, or any combination of thereof. The galvanometer may comprise a mirror. The scanner may comprise a modulator. The scanner may comprise a polygonal mirror. The scanner can be the same scanner for two or more energy sources and/or beams. The scanner may comprise an optical setup. At least two (e.g., each) energy source and/or beam may have a separate scanner. The energy sources can be translated independently of each other. In some cases, at least two energy sources and/or beams can be translated at different rates, and/or along different paths. For example, the movement of the first energy source may be faster (e.g., greater rate) as compared to the movement of the second energy source. The systems and/or apparatuses disclosed herein may comprise one or more shutters (e.g., safety shutters). The energy beam(s), energy source(s), and/or the platform can be moved by the scanner. The galvanometer scanner may comprise a two-axis galvanometer scanner. The scanner may comprise a modulator (e.g., as described herein). The energy source(s) can project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The energy source(s) can be modulated. The scanner can be included in an optical system (e.g., optical setup) that is configured to direct energy from the energy source to a predetermined position on the target surface (e.g., exposed surface of the powder bed). The controller can be programmed to control a trajectory of the energy source(s) with the aid of the optical system. The controller can regulate a supply of energy from the energy source to the material (e.g., at the target surface) to form a transformed material.

The energy beam(s) emitted by the energy source(s) can be modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an aucusto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

The energy beam (e.g., transforming energy beam) may comprise a Gaussian energy beam. The energy beam may have any cross-sectional shape comprising an ellipse (e.g., circle), or a polygon. The energy beam may have a cross section with a FLS (e.g., diameter) of at least about 50 micrometers (μm), 100 μm, 150 μm, 200 μm, or 250 μm. The energy beam may have a cross section with a FLS of at most about 60 micrometers (μm), 100 μm, 150 μm, 200 μm, or 250 μm. The energy beam may have a cross section with a FLS of any value between the afore-mentioned values (e.g., from about 50 μm to about 250 μm, from about 50 μm to about 150 μm, or from about 150 μm to about 250 μm). The powder density (e.g., power per unit area) of the energy beam may at least about 10000 W/mm², 20000 W/mm², 30000 W/mm², 50000 W/mm², 60000 W/mm², 70000 W/mm², 80000 W/mm², 90000 W/mm², or 100000 W/mm². The powder density of the energy beam may be at most about 10000 W/mm², 20000 W/mm², 30000 W/mm², 50000 W/mm², 60000 W/mm², 70000 W/mm², 80000 W/mm², 90000 W/mm², or 100000 W/mm². The powder density of the energy beam may be any value between the afore-mentioned values (e.g., from about 10000 W/mm² to about 100000 W/mm², from about 10000 W/mm² to about 50000 W/mm², or from about 50000 W/mm² to about 100000 W/mm²). The scanning speed of the energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the energy beam may be at most about 50 mm/sec, 100 mm/sec, 500 mm/sec, 1000 mm/sec, 2000 mm/sec, 3000 mm/sec, 4000 mm/sec, or 50000 mm/sec. The scanning speed of the energy beam may any value between the afore-mentioned values (e.g., from about 50 mm/sec to about 50000 mm/sec, from about 50 mm/sec to about 3000 mm/sec, or from about 2000 mm/sec to about 50000 mm/sec). The energy beam may be continuous or non-continuous (e.g., pulsing). The energy beam may be modulated before and/or during the formation of a transformed material as part of the 3D object. The energy beam may be modulated before and/or during the 3D printing process.

The 3D printing system and/or apparatus may be the one described in provisional patent application Ser. No. 62/265,817, in Provisional Patent Application Ser. No. 62/317,070, in patent application Ser. No. 15/374,535, or in Patent Application serial number PCT/US16/66000, all of which are incorporated herein by reference in their entirety.

The 3D printing system or apparatus may comprise a layer dispensing mechanism may dispense the powder material (e.g., in the direction of the platform), level, distribute, spread, and/or remove the powder material in the powder bed. The layer dispensing mechanism may be utilized to form the powder bed. The layer dispensing mechanism may be utilized to form the layer of powder material (or a portion thereof). The layer dispensing mechanism may be utilized to level (e.g., planarize) the layer of powder material (or a portion thereof). The leveling may be to a predetermined height. The layer dispensing mechanism may comprise at least one, two or three of a (i) powder dispensing mechanism (e.g., FIG. 1, 116), (ii) powder leveling mechanism (e.g., FIG. 1, 117), and (iii) powder removal mechanism (e.g., FIG. 1, 118). The layer dispensing mechanism may be controlled by the controller. The layer dispensing mechanism or any of its components can be any of those disclosed in provisional patent application Ser. No. 62/265,817, in Provisional Patent Application Ser. No. 62/317,070, in patent application Ser. No. 15/374,535, or in Patent Application serial number PCT/US16/66000, or in patent application serial number PCT/US15/36802, all of which are incorporated herein by reference in their entirety. The layer dispensing system may comprise a hopper. The layer dispensing system may comprise (e.g., may be) a recoater.

One or more sensors (at least one sensor) can detect the topology of the exposed surface of the powder bed and/or the exposed surface of the 3D object (or any portion thereof). The sensor can detect the amount of powder material deposited in the powder bed. The sensor can comprise a proximity sensor. For example, the sensor may detect the amount of powder material deposited on the platform or on the exposes surface of a powder bed. The sensor may detect the physical state of material deposited on the target surface (e.g., liquid or solid (e.g., powder or bulk)). The sensor can detect the microstructure (e.g., crystallinity) of powder material deposited on the target surface. The sensor may detect the amount of powder material disposed by the layer dispensing mechanism (e.g., powder dispenser). The sensor may detect the amount of powder material that is relocated by the layer dispensing mechanism (e.g., by the leveling mechanism). The sensor can detect the temperature of the powder and/or transformed material in the powder bed. The sensor may detect the temperature of the powder material in a powder dispensing mechanism, and/or in the powder bed. The sensor may detect the temperature of the powder material during and/or after its transformation. The sensor may detect the temperature and/or pressure of the atmosphere within the enclosure (e.g., chamber). The sensor may detect the temperature of the material (e.g., powder) bed at one or more locations.

The at least one sensor can be operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may comprise temperature sensor, weight sensor, material (e.g., powder) level sensor, metrology sensor, gas sensor, or humidity sensor. The metrology sensor may comprise a measurement sensor (e.g., height, length, width, angle, and/or volume). The metrology sensor may comprise a magnetic, acceleration, orientation, or optical sensor. The sensor may transmit and/or receive sound (e.g., echo), magnetic, electronic, and/or electromagnetic signal. The electromagnetic signal may comprise a visible, infrared, ultraviolet, ultrasound, radio wave, or microwave signal. The metrology sensor may measure a vertical, horizontal, and/or angular position of at least a portion of the target surface. The metrology sensor may measure a gap. The metrology sensor may measure at least a portion of the layer of material. The layer of material may be a powder material, transformed material, or hardened material. The metrology sensor may measure at least a portion of the 3D object. The gas sensor may sense any of the gas. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may be coupled to a processor that would perform image processing by using at least one sensor generated signal. The temperature sensor may comprise a camera (e.g., IR camera, CCD camera). The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensors, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The weight of the powder bed can be monitored by one or more weight sensors. The weight sensor(s) may be disposed in, and/or adjacent to the powder bed. A weight sensor disposed in the powder bed can be disposed at the bottom of the powder bed (e.g., adjacent to the platform). The weight sensor can be between the bottom of the enclosure (e.g., FIG. 1, 111) and the substrate (e.g., FIG. 1, 109) on which the base (e.g., FIG. 1, 102) or the powder bed (e.g., FIG. 1, 104) may be disposed. The weight sensor can be between the bottom of the enclosure and the base on which the powder bed may be disposed. The weight sensor can be between the bottom of the enclosure and the powder bed. A weight sensor can comprise a pressure sensor. The weight sensor may comprise a spring scale, a hydraulic scale, a pneumatic scale, or a balance. At least a portion of the pressure sensor can be exposed on a bottom surface of the powder bed. The weight sensor can comprise a button load cell. The button load cell can sense pressure from powder material adjacent to the load cell. In an example, one or more sensors (e.g., optical sensors or optical level sensors) can be provided adjacent to the powder bed such as above, below, or to the side of the powder bed. In some examples, the one or more sensors can sense the level (e.g., height and/or amount) of powder material in the powder bed. The powder material (e.g., powder) level sensor can be in communication with a layer dispensing mechanism (e.g., powder dispenser). Alternatively, or additionally a sensor can be configured to monitor the weight of the powder bed by monitoring a weight of a structure that contains the powder bed. One or more position sensors (e.g., height sensors) can measure the height of the powder bed relative to the platform. The position sensors can be optical sensors. The position sensors can determine a distance between one or more energy beams (e.g., a laser or an electron beam) and the exposed surface of the material (e.g., powder) bed. The one or more sensors may be connected to a control system (e.g., to a processor and/or to a computer).

The systems and/or apparatuses disclosed herein may comprise one or more motors. The motors may comprise servomotors. The servomotors may comprise actuated linear lead screw drive motors. The motors may comprise belt drive motors. The motors may comprise rotary encoders. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators. The systems and/or apparatuses disclosed herein may comprise one or more pistons.

In some examples, a pressure system is in fluid communication with the enclosure. The pressure system can be configured to regulate the pressure in the enclosure. In some examples, the pressure system includes one or more pumps. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump, or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valveless pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump.

In some examples, the pressure system includes one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector. The pressure system can include valves; such as throttle valves. The pressure system can include a pressure sensor for measuring the pressure of the chamber and relaying the pressure to the controller, which can regulate the pressure with the aid of one or more vacuum pumps of the pressure system. The pressure sensor can be coupled to a control system (e.g., controller). The pressure can be electronically or manually controlled.

The systems, apparatuses, and/or methods described herein can comprise a material recycling mechanism. The recycling mechanism can collect at least unused powder material and return the unused powder material to a reservoir of a powder dispensing mechanism (e.g., the powder dispensing reservoir), or to a bulk reservoir that feeds the powder dispensing mechanism. The recycling mechanism and the bulk reservoir are described in patent application No. 62/265,817, in Provisional Patent Application Ser. No. 62/317,070, in patent application Ser. No. 15/374,535, or in Patent Application serial number PCT/US16/66000, all of which are incorporated herein by reference in their entirety.

In some cases, unused material (e.g., remainder) can surround the 3D object in the powder bed. The unused material can be substantially removed from the 3D object. The unused material may comprise powder material. Substantial removal may refer to material covering at most about 20%, 15%, 10%, 8%, 6%, 4%, 2%, 1%, 0.5%, or 0.1% of the surface of the 3D object after removal. Substantial removal may refer to removal of all the material that was disposed in the powder bed and remained as powder material at the end of the 3D printing process (i.e., the remainder), except for at most about 10%, 3%, 1%, 0.3%, or 0.1% of the weight of the remainder. Substantial removal may refer to removal of all the remainder except for at most about 50%, 10%, 3%, 1%, 0.3%, or 0.1% of the weight of the printed 3D object. The unused material can be removed to permit retrieval of the 3D object without digging through the powder bed. For example, the unused material can be suctioned out of the powder bed by one or more vacuum ports (e.g., nozzles) built adjacent to the powder bed, by brushing off the remainder of unused material, by lifting the 3D object from the unused material, by allowing the unused material to flow away from the 3D object (e.g., by opening an exit opening port on the side(s) and/or on the bottom of the powder bed from which the unused material can exit). After the unused material is evacuated, the 3D object can be removed. The unused powder material can be re-circulated to a material reservoir for use in future builds. The removal of the remainder may be effectuated as described in patent application No. 62/265,817, in Provisional Patent Application Ser. No. 62/317,070, or in patent application Ser. No. 15/374,535, in Patent Application serial number PCT/US16/66000, or in patent application number PCT/US15/36802, all of which are incorporated herein by reference in their entirety. In some cases, cooling gas can be directed to the hardened material (e.g., 3D object) for cooling the hardened material during and/or following its retrieval.

In some cases, a layer of the 3D object can be formed within at most about 1 hour (h), 30 minutes (min), 20 min, 10 min, 5 min, 1 min, 40 seconds (s), 20 s, 10 s, 9 s, 8 s, 7 s, 6 s, 5 s, 4 s, 3 s, 2 s, or 1 s. A layer of the 3D object can be formed within at least about 30 minutes (min), 20 min, 10 min, 5 min, 1 min, 40 seconds (s), 20 s, 10 s, 9 s, 8 s, 7 s, 6 s, 5 s, 4 s, 3 s, 2 s, or 1 s. A layer of the 3D can be formed within any time between the afore-mentioned time scales (e.g., from about 1 h to about 1 s, from about 10 min to about 1 s, from about 40 s to about 1 s, from about 10 s to about 1 s, or from about 5 s to about 1 s).

The final form of the 3D object can be retrieved soon after cooling of a final layer of hardened material. Soon after cooling may be at most about 1 day, 12 hours (h), 6 h, 5 h, 4 h, 3 h, 2 h, 1 h, 30 minutes, 15 minutes, 5 minutes, 240 s, 220 s, 200 s, 180 s, 160 s, 140 s, 120 s, 100 s, 80 s, 60 s, 40 s, 20 s, 10 s, 9 s, 8 s, 7 s, 6 s, 5 s, 4 s, 3 s, 2 s, or 1 s. Soon after cooling may be between any of the afore-mentioned time values (e.g., from about 1 s to about 1 day, from about 1 s to about 1 hour, from about 30 minutes to about 1 day, from about 20 s to about 240 s, from about 12 h to about 1 s, from about 12 h to about 30 min, from about 1 h to about 1 s, or from about 30 min to about 40 s). In some cases, the cooling can occur by method comprising active cooling by convection using a cooled gas or gas mixture comprising argon, nitrogen, helium, neon, krypton, xenon, hydrogen, carbon monoxide, carbon dioxide, or oxygen. Cooling may be cooling to a handling temperature. Cooling may be cooling to a temperature that allows a person to handle the 3D object.

The generated 3D object may require very little or no further processing after its retrieval. In some examples, the diminished further processing or lack thereof, will afford a 3D printing process that requires smaller amount of energy and/or less waste as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the afore-mentioned values (e.g., from about 1.1 to about 10, or from about 1.5 to about 5). Further processing may comprise trimming. Further processing may comprise polishing (e.g., sanding). The generated 3D object can be retrieved and finalized without removal of transformed material and/or auxiliary features. The 3D object can be retrieved when the 3D object, composed of hardened (e.g., solidified) material, is at a handling temperature that is suitable to permit its removal from the powder bed without its substantial deformation. The handling temperature can be a temperature that is suitable for packaging of the 3D object. The handling temperature a can be at most about 120° C., 100° C., 80° C., 60° C., 40° C., 30° C., 25° C., 20° C., 10° C., or 5° C. The handling temperature can be of any value between the afore-mentioned temperature values (e.g., from about 120° C. to about 20° C., from about 40° C. to about 5° C., or from about 40° C. to about 10° C.).

The methods and systems provided herein can result in fast and/or efficient formation of 3D objects. In some cases, the 3D object can be transported within at most about 120 min, 100 min, 80 min, 60 min, 40 min, 30 min, 20 min, 10 min, or 5 min after the last layer of the object hardens (e.g., solidifies). In some cases, the 3D object can be transported within at least about 120 min, 100 min, 80 min, 60 min, 40 min, 30 min, 20 min, 10 min, or 5 min after the last layer of the object forms (e.g., hardens). In some cases, the 3D object can be transported within any time between the above-mentioned values (e.g., from about 5 min to about 120 min, from about 5 min to about 60 min, or from about 60 min to about 120 min). The 3D object can be transported once it cools to a temperature of at most about 100° C., 90° C., 80° C., 70° C., 60° C., 50° C., 40° C., 30° C., 25° C., 20° C., 15° C., 10° C., or 5° C. The 3D object can be transported once it cools to a temperature value between the above-mentioned temperature values (e.g., from about 5° C. to about 100° C., from about 5° C. to about 40° C., or from about 15° C. to about 40° C.). Transporting the 3D object can comprise packaging and/or labeling the 3D object. In some cases, the 3D object can be transported directly to a consumer.

The methods, systems, apparatuses, and/or software presented herein may facilitate formation of custom or a stock 3D objects for a customer. A customer can be an individual, a corporation, organization, government, non-profit organization, company, hospital, medical practitioner, engineer, retailer, any other entity, or individual. The customer may be one that is interested in receiving the 3D object and/or that ordered the 3D object. A customer can submit a request for formation of a 3D object. The customer can provide an item of value in exchange for the 3D object. The customer can provide a design or a model for the 3D object. The customer can provide the design in the form of a stereo lithography (STL) file. The customer can provide a design wherein the design can be a definition of the shape and/or dimensions of the 3D object in any other numerical or physical form. In some cases, the customer can provide a 3D model, sketch, and/or image as a design of an object to be generated. The design can be transformed in to instructions usable by the printing system to additively generate the 3D object. The customer can provide a request to form the 3D object from a specific material or group of materials (e.g., a material as described herein). In some cases, the design may not contain auxiliary features (or marks of any past presence of auxiliary support features).

In response to the customer request, the 3D object can be formed or generated as described herein. In some cases, the 3D object can be formed by an additive 3D printing process (e.g., additive manufacturing). Additively generating the 3D object can comprise successively depositing and transforming (e.g., melting) a powder material comprising one or more materials as specified by the customer. The 3D object can be subsequently delivered to the customer. The 3D object can be formed without generation or removal of auxiliary features (e.g., that is indicative of a presence or removal of the auxiliary support feature). Auxiliary features can be support features that prevent a 3D object from shifting, deforming or moving during the formation of the 3D object.

The 3D object (e.g., solidified material) that is generated for the customer can have an average deviation value from the intended dimensions (e.g., specified by the customer, or designated according to a model of the 3D object) of at most about 0.5 microns (μm), 1 μm, 5 μm, 10 μm, 30 μm, 100 μm, 300 μm, or less. The deviation can be any value between the afore-mentioned values (e.g., from about 0.5 μm to about 300 μm, from about 10 μm to about 50 μm, from about 15 μm to about 85 μm, from about 5 μm to about 45 μm, or from about 15 μm to about 35 μm). The 3D object can have a deviation from the intended dimensions in a specific direction, according to the formula Dv+L/K_{Dv}, wherein Dv is a deviation value, L is the length of the 3D object in a specific direction, and K_{Dv} is a constant. Dv can have a value of at most about 300 μm, 200 μm, 100 μm, 50 μm, 40 μm, 30 μm, 20 μm, 10 μm, 5 μm, 1 μm, or 0.5 μm. Dv can have a value of at least about 0.5 μm, 1 μm, 5 μm, 5 μm, 10 μm, 20 μm, 30 μm, 50 μm, 70 μm, 100 μm, or 300 μm. Dv can have any value between the afore-mentioned values (e.g., from about 0.5 μm to about 300 μm, from about 10 μm to about 50 μm, from about 15 μm to about 85 μm, from about 5 μm to about 45 μm, or from about 15 μm to about 35 μm). K_{DV} can have a value of at most about 3000, 2500, 2000, 1500, 1000, or 500. K_{DV} can have a value of at least about 500, 1000, 1500, 2000, 2500, or 3000. K_{DV} can have any value between the afore-mentioned values (e.g., from about 3000 to about 500, from about 1000 to about 2500, from about 500 to about 2000, from about 1000 to about 3000, or from about 1000 to about 2500).

The intended dimensions can be derived from a model design. The 3D part can have the stated accuracy value immediately after its formation, without additional processing or manipulation. Receiving the order for the object, formation of the object, and delivery of the object to the customer can take at most about 7 days, 6 days, 5 days, 3 days, 2 days, 1 day, 12 hours, 6 hours, 5 hours, 4 hours, 3 hours, 2 hours, 1 hour, 30 min, 20 min, 10 min, 5 min, 1 min, 30 seconds, or 10 seconds. Receiving the order for the object, formation of the object, and delivery of the object to the customer can take a period of time between any of the afore-mentioned time periods (e.g., from about 10 seconds to about 7 days, from about 10 seconds to about 12 hours, from about 12 hours to about 7 days, or from about 12 hours to about 10 minutes). In some cases, the 3D object can be generated in a period between any of the afore-mentioned time periods (e.g., from about 10 seconds to about 7 days, from about 10 seconds to about 12 hours, from about 12 hours to about 7 days, or from about 12 hours to about 10 minutes). The time can vary based on the physical characteristics of the object, including the size and/or complexity of the object.

The system and/or apparatus can comprise a controlling mechanism (e.g., a controller). The methods, systems, apparatuses, and/or software disclosed herein may incorporate a controller that controls one or more of the components described herein. The controller may comprise a computer-processing unit (e.g., a computer) coupled to any of the systems and/or apparatuses, or their respective components (e.g., the energy source(s)). Alternatively or additionally, the systems and/or apparatuses disclosed herein may be coupled to a processing unit. Alternatively or additionally, the methods may incorporate the operation of a processing unit. The computer can be operatively coupled through a wired and/or through a wireless connection. In some cases, the computer can be on board a user device. A user device can be a laptop computer, desktop computer, tablet, smartphone, or another computing device. The controller can be in communication with a cloud computer system and/or a server. The controller can be programmed to selectively direct the energy source(s) to apply energy to the at least a portion of the target surface at a power per unit area. The controller can be in communication with the scanner configured to articulate the energy source(s) to apply energy to at least a portion of the target surface at a power per unit area.

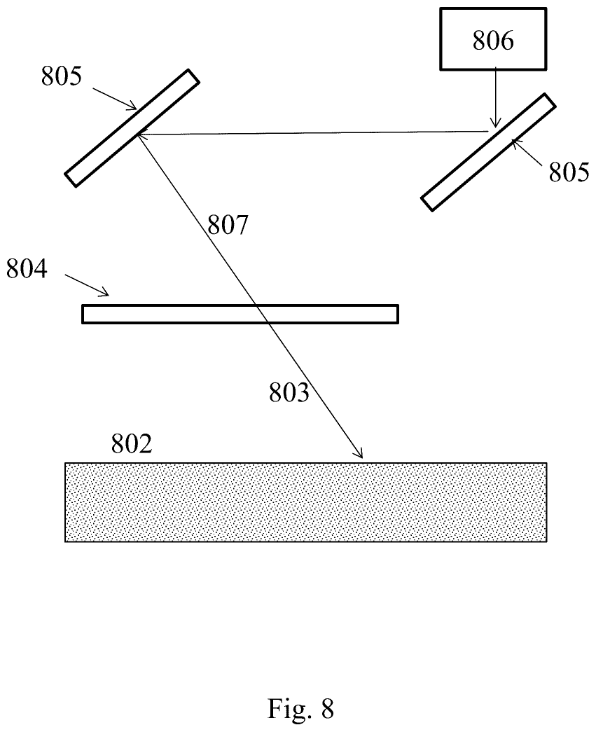

The controller may control the layer dispensing mechanism and/or any of its components. The controller may control the platform. The controller may control the one or more sensors. The controller may control any of the components of the 3D printing system and/or apparatus. The controller may control any of the mechanisms used to effectuate the methods described herein. The control may comprise controlling (e.g., directing and/or regulating) the speed (velocity) of movement of any of the 3D printing mechanisms and/or components. The movement may be horizontal, vertical, and/or in an angle (planar and/or compound). The controller may control at least one characteristic of the transforming energy beam. The controller may control the movement of the transforming energy beam (e.g., according to a path). The controller may control the source of the (transforming) energy beam. The energy beam (e.g., transforming energy beam, or sensing energy beam) may travel through an optical setup. The optical setup may comprise a mirror, a lens, a focusing device, a prism, or an optical window. FIG. 8 shows an example of an optical setup in which an energy beam is projected from the energy source 806, and is deflected by two mirrors 805, and travels through an optical element 804. The optical element 804 can be an optical window, in which case the incoming beam 807 is substantially unaltered 803 after crossing the optical window. The optical element 804 can be a focus altering device, in which case the focus (e.g., crossection) of the incoming beam 807 is altered after passing through the optical element 804 and emerging as the beam 803. The controller may control the scanner that directs the movement of the transforming energy beam and/or platform.

The controller may control the level of pressure (e.g., vacuum, ambient, or positive pressure) in the powder removal mechanism powder dispensing mechanism, and/or the enclosure (e.g., chamber). The pressure level (e.g., vacuum, ambient, or positive pressure) may be constant or varied. The pressure level may be turned on and off manually and/or by the controller. The controller may control at least one characteristic and/or component of the layer dispensing mechanism. For example, the controller may control the direction and/or rate of movement of the layer dispensing mechanism and any of its components. The controller may control the cooling member (e.g., external and/or internal). The movement of the layer dispensing mechanism or any of its components may be predetermined. The movement of the layer dispensing mechanism or any of its components may be according to an algorithm. Other control examples can be found in patent applications No. 62/265,817, in Provisional Patent Application Ser. No. 62/317,070, in patent application Ser. No. 15/374,535, in Patent Application serial number PCT/US16/66000, or in patent application number PCT/US15/36802, all of which are incorporated herein by reference in their entirety. The control may be manual and/or automatic. The control may be programmed and/or be effectuated a whim. The control may be according to an algorithm. The algorithm may comprise a printing algorithm, or motion control algorithm. The algorithm may take into account the model of the 3D object.

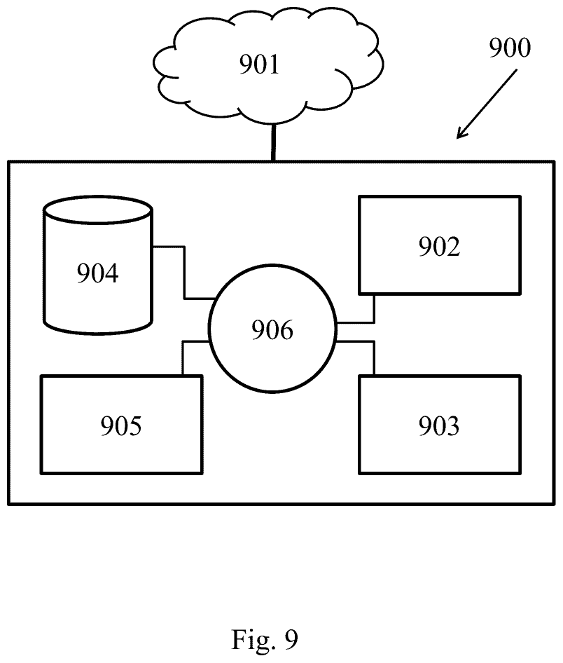

The controller may comprise a processing unit. The processing unit may be central. The processing unit may comprise a central processing unit (herein “CPU”). The controllers or control mechanisms (e.g., comprising a computer system) may be programmed to implement methods of the disclosure. The controller may control at least one component of the systems and/or apparatuses disclosed herein. FIG. 9 is a schematic example of a computer system 900 that is programmed or otherwise configured to facilitate the formation of a 3D object according to the methods provided herein. The computer system 900 can control (e.g., direct and/or regulate) various features of printing methods, apparatuses and systems of the present disclosure, such as, for example, regulating force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system 901 can be part of, or be in communication with, a printing system or apparatus, such as a 3D printing system or apparatus of the present disclosure. The computer may be coupled to one or more mechanisms disclosed herein, and/or any parts thereof. For example, the computer may be coupled to one or more sensors, valves, switches, motors, pumps, optical components, or any combination thereof.

The computer system 900 can include a processing unit 906 (also “processor,” “computer” and “computer processor” used herein). The computer system may include memory or memory location 902 (e.g., random-access memory, read-only memory, flash memory), electronic storage unit 904 (e.g., hard disk), communication interface 903 (e.g., network adapter) for communicating with one or more other systems, and peripheral devices 905, such as cache, other memory, data storage and/or electronic display adapters. The memory 902, storage unit 904, interface 903, and peripheral devices 905 are in communication with the processing unit 906 through a communication bus (solid lines), such as a motherboard. The storage unit can be a data storage unit (or data repository) for storing data. The computer system can be operatively coupled to a computer network (“network”) 901 with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 902. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 900 can be included in the circuit.

The storage unit 904 can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

Methods as described herein can be implemented by way of machine (e.g., computer processor) executable code stored on an electronic storage location of the computer system, such as, for example, on the memory 902 or electronic storage unit 904. The machine executable or machine-readable code can be provided in the form of software. During use, the processor 906 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code, or can be compiled during runtime. The code can be supplied in a programming language that can be selected to enable the code to execute in a pre-compiled or as-compiled fashion.

The processing unit may include one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The integrated circuit chip may comprise at least about 0.2 billion transistors (BT), 0.5 BT, 1 BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm 2, or 800 mm². The integrated circuit chip may have an area of at most about 50 mm², 60 mm², 70 mm², 80 mm², 90 mm², 100 mm², 200 mm², 300 mm², 400 mm², 500 mm², 600 mm², 700 mm 2, or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. The multiplicity of cores may include at least about 2, 10, 40, 100, 400, 1000, 2000, 3000, 4000, 5000, 6000, 7000, 8000, 9000, 10000, 11000, 12000, 13000, 14000 or 15000 cores. The multiplicity of cores may include at most about 1000, 2000, 3000, 4000, 5000, 6000, 7000, 8000, 9000, 10000, 11000, 12000, 13000, 14000, 15000, 20000, 30000, or 40000 cores. The multiplicity of cores may include cores of any number between the afore-mentioned numbers (e.g., from about 2 to about 40000, from about 2 to about 400, from about 400 to about 4000, from about 2000 to about 4000, from about 4000 to about 10000, from about 4000 to about 15000, or from about 15000 to about 40000 cores). In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 0.1 Tera FLOPS (T-FLOPS), 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, 10 T-FLOPS, 20 T-FLOPS, or 30 T-FLOPS. The number of FLOPS may be any value between the afore-mentioned values (e.g., from about 0.1 T-FLOP to about 30 T-FLOP, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS). In some processors (e.g., FPGA), the operations per second may be measured as (e.g., Giga) multiply-accumulate operations per second (e.g., MACs or GMACs). The MACs value can be equal to any of the T-FLOPS values mentioned herein measured as Tera-MACs (T-MACs) instead of T-FLOPS respectively. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI refers to Message Passing Interface.

The computer system may include hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

The computer system may include an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

The computer system may include configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration.

The computing system may include an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most about 0.1 microsecond (μs), 1 μs, 10 μs, 100 μs, or 1 millisecond (ms). The physical unit may produce the algorithm output in any time between the above mentioned times (e.g., from about 0.1 μs, to about 1 ms, from about 0.1 μs, to about 100 μs, or from about 0.1 μs to about 10 μs).

In some instances, the controller may use calculations, real time measurements, or any combination thereof to regulate the energy beam(s). The sensor (e.g., temperature and/or positional sensor) may provide a signal (e.g., input for the controller and/or processor) at a rate of at least about 0.1 KHz, 1 KHz, 10 KHz, 100 KHz, 1000 KHz, or 10000 KHz). The sensor may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processing unit may be at least about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may be at most about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real time measurements may be conducted during the 3D printing process. The real-time measurements may be in-situ measurements in the 3D printing system and/or apparatus. The real time measurements may be during the formation of the 3D object. In some instances, the processing unit may use the signal obtained from the at least one sensor to provide a processing unit output, which output is provided by the processing system at a speed of at most about 100 min, 50 min, 25 min, 15 min, 10 min, 5 min, 1 min, 0.5 min (i.e., 30 sec), 15 sec, 10 sec, 5 sec, 1 sec, 0.5 sec, 0.25 sec, 0.2 sec, 0.1 sec, 80 milliseconds (msec), 50 msec, 10 msec, 5 msec, or 1 msec. In some instances, the processing unit may use the signal obtained from the at least one sensor to provide a processing unit output, which output is provided at a speed of any value between the afore-mentioned values (e.g., from about 100 min to about 1 msec, from about 100 min to about 10 min, from about 10 min to about 1 min, from about 5 min to about 0.5 min, from about 30 sec to about 0.1 sec, or from about 0.1 sec to about 1 msec). The processing unit output may comprise an evaluation of the temperature at a location, position at a location (e.g., vertical and/or horizontal), or a map of locations. The location may be on the target surface. The map may comprise a topological or temperature map.

The processing unit may use the signal obtained from the at least one sensor in an algorithm that is used in controlling the energy beam. The algorithm may comprise the path of the energy beam. In some instances, the algorithm may be used to alter the path of the energy beam on the target surface. The path may deviate from a cross section of a model corresponding to the desired 3D object. The processing unit may use the output in an algorithm that is used in determining the manner in which a model of the desired 3D object may be sliced. The processing unit may use the signal obtained from the at least one sensor in an algorithm that is used to configure one or more parameters and/or apparatuses relating to the 3D printing process. The parameters may comprise a characteristics of the energy beam. The parameters may comprise movement of the platform and/or powder bed. The parameters may comprise relative movement of the energy beam and the powder bed. In some instances, the energy beam, the platform (e.g., powder bed disposed on the platform), or both may translate. Alternatively or additionally, the controller may use historical data for the control. Alternatively or additionally, the processing unit may use historical data in its one or more algorithms. The parameters may comprise the height of the layer of powder material disposed in the enclosure and/or the gap by which the cooling element (e.g., heat sink) is separated from the target surface. The target surface may be the exposed layer of the powder bed.

Aspects of the systems, apparatuses, and/or methods provided herein, such as the computer system, can be embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

The memory may comprise a random access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complement to that of the AND gate. The storage may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms (e.g., from the one or more sensors). The control may rely on historical data. The feedback mechanism may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the powder material. The output unit may output the amount of oxygen, water, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

The system and/or apparatus described herein (e.g., controller) and/or any of their components may comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen. The system and/or apparatus described herein (e.g., controller) and/or any of their components may comprise Bluetooth technology. The system and/or apparatus described herein (e.g., controller) and/or any of their components may comprise a communication port. The communication port may be a serial port or a parallel port. The communication port may be a Universal Serial Bus port (i.e., USB). The system and/or apparatus described herein (e.g., controller) and/or any of their components may comprise USB ports. The USB can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, E0h, EFh, FEh, or FFh. The system and/or apparatus described herein (e.g., controller) and/or any of their components may comprise a plug and/or a socket (e.g., electrical, AC power, DC power). The system and/or apparatus described herein (e.g., controller) and/or any of their components may comprise an adapter (e.g., AC and/or DC power adapter). The system and/or apparatus described herein (e.g., controller) and/or any of their components may comprise a power connector. The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

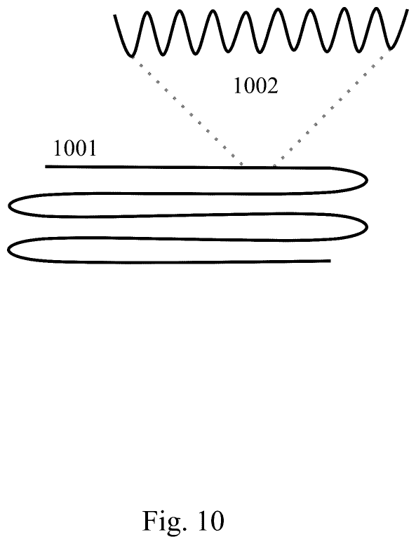

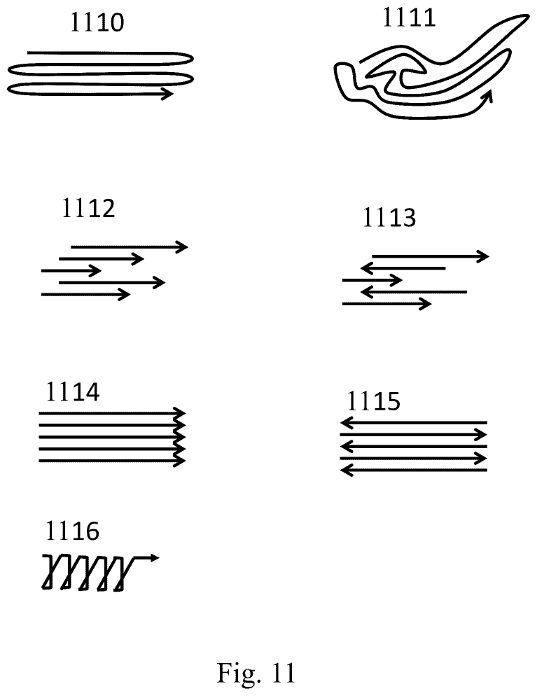

The systems, methods, and/or apparatuses disclosed herein may comprise receiving a request for a 3D object (e.g., from a customer). The request can include a model (e.g., CAD) of the desired 3D object. Alternatively or additionally, a model of the desired 3D object may be generated. The model may be used to generate 3D printing instructions. The 3D printing instructions may exclude the 3D model. The 3D printing instructions may be based on the 3D model. The 3D printing instructions may take the 3D model into account. The 3D printing instructions may be alternatively or additionally be based on simulations. The 3D printing instructions may use the 3D model. The 3D printing instructions may comprise using an algorithm (e.g., embedded in a software) that takes into account the 3D model, simulations, historical data, sensor input, or any combination thereof. The processor may compute the algorithm during the 3D printing process (e.g., in real-time), during the formation of the 3D object, prior to the 3D printing process, after the 3D printing process, or any combination thereof. The processor may compute the algorithm in the interval between pulses of the energy beam, during the dwell time of the energy beam, before the energy beam translates to a new position, while the energy beam is not translating, while the energy beam does not irradiate the target surface, while the energy beam irradiates the target surface, or any combination thereof. For example, the processor may compute the algorithm while the energy beam translates and does substantially not irradiate the exposed surface. For example, the processor may compute the algorithm while the energy beam does not translate and irradiates the exposed surface. For example, the processor may compute the algorithm while the energy beam does not substantially translate and does substantially not irradiate the exposed surface. For example, the processor may compute the algorithm while the energy beam does translate and irradiates the exposed surface. The translation of the energy beam may be translation along an entire path or a portion thereof. The path may correspond to a cross section of the model of the 3D object. The translation of the energy beam may be translation along at least one hatching within the path. FIG. 11 shows examples of various paths. The direction of the arrow(s) in FIG. 11 represents the direction according to which a positon of the energy beam directed to the exposed surface of the powder bed is altered with respect to the powder bed. The various vectors depicted in FIG. 11, 1114 show an example of various hatchings. The respective movement of the energy beam with the powder bed may oscillate while traveling along the path. For example, the propagation of the energy beam along a path may be by small path deviations (e.g., variations such as oscillations). FIG. 10 shows an example of a path 1001. The sub path 1002 is a magnification of a portion of the path 1001 showing path deviations (e.g., oscillations).

While preferred embodiments of the present invention have been shown and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method for printing a three-dimensional object comprising:
(a) irradiating at a first position a first portion of a powder bed comprising a first powder and a second powder that is different from the first powder, which first powder comprises a first material, and wherein the second powder comprises a second material, which irradiating is to a temperature that is sufficient to melt the first powder of the first portion, and does not melt the second powder of the first portion, wherein the second powder comprises a particle that includes the second material;
(b) facilitating diffusion of the first material into the particle to form a requested alloy as at least a first segment of the three-dimensional object, which first material is of the first portion and which particle is of the first portion.

2. The method of claim 1, wherein the requested alloy is formed in situ during printing of the three-dimensional object.

3. The method of claim 1, wherein the first powder has a melting temperature that is lower than that of the second powder.

4. The method of claim 1, wherein the first material and/or the second material comprises an elemental metal, metal alloy, ceramic, or ceramic alloy.

5. The method of claim 1, wherein the requested alloy comprises a metal alloy or a ceramic alloy.

6. The method of claim 1, wherein the requested alloy comprises a diffusion pattern that is formed from diffusion of the first material into the particle that includes the second material in (b).

7. The method of claim 1, wherein the requested alloy is prone to form cracks and wherein the three-dimensional object is devoid or substantially devoid of cracks.

8. The method of claim 7, wherein the cracks are heat cracks.

9. The method of claim 1, further comprising irradiating at a second position a second portion of the powder bed to a temperature that is sufficient to melt the first powder in the second portion, and does not melt the second powder in the second portion.

10. The method of claim 9, further comprising facilitating diffusion of the first material into the particle to form a requested alloy as at least a second segment of the three-dimensional object, which first material is of the second portion, and which particle is of the second portion.

11. The method of claim 10, wherein the first segment is connected to the second segment as part of a layer of the three-dimensional object.

12. A system for printing a three-dimensional object comprising:
an enclosure configured to accommodate a powder bed comprising a first powder and a second powder that is different from the first powder, which first powder comprises a first material, and which the second powder comprises a second material, wherein the second powder comprises a particle that includes the second material;
an energy source configured to generate an energy beam that melts a portion of the powder bed, wherein the energy source is operatively coupled to the enclosure;
at least one controller that is operatively coupled to the powder bed and to the energy beam and is separately or collectively configured to perform: operation (i) direct the energy beam to irradiate at a first position a first portion of a powder bed to a temperature that is sufficient to melt the first powder of the first portion, and does not melt the second powder of the first portion, wherein the second powder comprises a particle that includes the second material; and
operation (ii) facilitate diffusion of the first material into the particle to form a requested alloy as at least a first segment of the three-dimensional object, which first material is of the first portion, and wherein the particle is of the first portion.

13. The system of claim 12, wherein the at least one controller facilitates a real-time control of a temperature of the first portion and/or of an area adjacent to the first portion.

14. The system of claim 13, wherein the real-time control comprises at least one feedback loop.

15. The system of claim 14, wherein the feedback loop comprises sensing the temperature of the first portion, and/or of an area adjacent to the first portion.

16. The system of claim 15, wherein adjacent is up to five diameters of a horizontal cross section of a melt pool that is formed by irradiation of the first portion.

17. The system of claim 15, wherein the sensing is in real time.

18. The system of claim 17, wherein real time is during formation of (I) a melt pool, (II) layer of the three-dimensional object, and/or (III) the three-dimensional object.

19. The system of claim 12, further comprising a sensor operatively coupled to the enclosure and to the at least one controller, and wherein the at least one controller is configured to control at least one characteristic of the energy beam based on a signal from the sensor.

20. The system of claim 19, wherein the sensor is a temperature sensor.
